(19) United States
(12) Patent Application Publication
(10) Pub. No.: US 2026/0213829 A1
(43) Pub. Date: Jul. 23, 2026

(54) TECHNIQUES FOR SCHEDULING COMMUNICATION RESOURCES FOR BACKSCATTER MODULATION

(71) Applicant: QUALCOMM Incorporated, San Diego, CA (US)

(72) Inventors: Ahmed ELSHAFIE, San Diego, CA (US); Seyedkianoush HOSSEINI, San Diego, CA (US); Huilin XU, Temecula, CA (US); Linhai HE, San Diego, CA (US); Wei YANG, San Diego, CA (US); Zhikun WU, Beijing (CN); Wanshi CHEN, San Diego, CA (US)

(21) Appl. No.: 19/139,805

(22) PCT Filed: Mar. 9, 2023
(86) PCT No.: PCT/CN2023/080477

§ 371 Date: Jun. 16, 2025

(51) Int. Cl. H04B 7/155; H02J 50/00; H02J 50/20; H04B 7/06; H04W 72/23

(52) U.S. Cl. CPC H04B 7/15542; H02J 50/001; H02J 50/20; H04B 7/06952; H04W 72/23

(57) ABSTRACT

Methods, systems, and devices for wireless communications are described. Bi-static communications may involve an energy-harvesting (EH) capable device. An interrogating network node (e.g., a network node that transmits an interrogating signal to an EH-capable device) or a reader network node (e.g., a network node that receives a backscatter response) may transmit a scheduling request to a scheduling network node. Upon receipt of the scheduling request, the scheduling network node may transmit two grants. One of the grants schedules a transmission from the source network entity to the EH-capable device. The other grant schedules reception of a backscatter response from the EH-capable device to the transmission. The source network node may communicate a transmission to the EH-capable device in accordance with the first grant, and the reader network node may receive the backscatter response to the transmission from the EH-capable device in accordance with the second grant.

### CROSS REFERENCE

The present Application for Patent is a 371 national phase filing of International Patent Application No. PCT/CN2023/080477 by ELSHAFIE et al., entitled “TECHNIQUES FOR SCHEDULING COMMUNICATION RESOURCES FOR BACKSCATTER MODULATION,” filed Mar. 9, 2023, assigned to the assignee hereof, and expressly incorporated by reference herein.

### INTRODUCTION

The following relates to wireless communications that pertain to techniques for scheduling communication resources for backscatter modulation.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for scheduling communication resources for backscatter modulation. For example, the described techniques provide for scheduling bi-static communications involving an energy-harvesting (EH) capable device. Either an interrogating network node (e.g., a source network node such as a user equipment (UE) that transmits an interrogating signal to an EH-capable device) or a reader network node (e.g., a network node such as another UE that receives a backscatter response to the interrogating signal) may transmit a scheduling request to a scheduling network node (e.g., a network entity). Upon receipt of the scheduling request, the scheduling network node may transmit two grants. One of the grants is to the source network entity and is for a transmission from the source network entity to the EH-capable device. The other grant is to the reader network entity and is for reception of a backscatter response from the EH-capable device to the transmission from the source network entity. The source network node may communicate a transmission to the EH-capable device in accordance with the first grant, and the reader network node may receive the backscatter response to the transmission from the EH-capable device in accordance with the second grant.

A method for wireless communications at a first network node is described. The method may include receiving, from one of a second network node or a third network node, a scheduling request, where the scheduling request is for a transmission from the second network node to an EH-capable device configured to perform backscattering, transmitting, to the second network node, a first grant based on the scheduling request, where the first grant schedules a communication resource for the transmission, and transmitting, to the third network node, a second grant based on the scheduling request, where the second grant schedules the communication resource for reception of a backscatter response from the EH-capable device.

A first network node for wireless communications is described. The first network node may include a memory; and at least one processor coupled to the memory. The at least one processor is configured to receive, from one of a second network node or a third network node, a scheduling request, where the scheduling request is for a transmission from the second network node to an EH-capable device configured to perform backscattering, transmit, to the second network node, a first grant based on the scheduling request, where the first grant schedules a communication resource for the transmission, and transmit, to the third network node, a second grant based on the scheduling request, where the second grant schedules the communication resource for reception of a backscatter response from the EH-capable device.

Another apparatus for wireless communications at a first network node is described. The apparatus may include means for receiving, from one of a second network node or a third network node, a scheduling request, where the scheduling request is for a transmission from the second network node to an EH-capable device configured to perform backscattering, means for transmitting, to the second network node, a first grant based on the scheduling request, where the first grant schedules a communication resource for the transmission, and means for transmitting, to the third network node, a second grant based on the scheduling request, where the second grant schedules the communication resource for reception of a backscatter response from the EH-capable device.

A non-transitory computer-readable having code for wireless communications stored thereon is described. The code, when executed by a first network node, causes the first network node to receive, from one of a second network node or a third network node, a scheduling request, where the scheduling request is for a transmission from the second network node to an EH-capable device configured to perform backscattering, transmit, to the second network node, a first grant based on the scheduling request, where the first grant schedules a communication resource for the transmission, and transmit, to the third network node, a second grant based on the scheduling request, where the second grant schedules the communication resource for reception of a backscatter response from the EH-capable device.

In some examples of the method, first network node, apparatuses, and non-transitory computer-readable medium described herein, the first grant may be first DCI (DCI) configured to activate a configured grant (CG) occasion for the second network node, the second grant may be second DCI configured to activate the CG occasion for the third network node, and the CG occasion may be the communication resource.

In some examples of the method, first network node, apparatuses, and non-transitory computer-readable medium described herein, each of the first DCI and the second DCI indicates a same quantity of slots as a duration of the CG occasion.

Some examples of the method, first network node, apparatuses, and non-transitory computer-readable medium described herein may further include operations, features, means, or instructions for transmitting, prior to transmission of the first grant and the second grant, an indication of one or more candidate durations of the CG occasion, where the same quantity of slots indicated in the first DCI and in the second DCI as the duration of the CG occasion may be a designated one of the one or more candidate durations.

In some examples of the method, first network node, apparatuses, and non-transitory computer-readable medium described herein, the first grant may be indicative of a first quantity of slots for the transmission and the second grant may be indicative of a second quantity of slots for the reception.

In some examples of the method, first network node, apparatuses, and non-transitory computer-readable medium described herein, at least one of the first grant or the second grant may be indicative of a division of the communication resource into a set of multiple slot types, the set of multiple slot types including at least one of a first slot type, a second slot type, or a third slot type and the first slot type may be for provision of command information to the EH-capable device, the second slot type may be for provision of a continuous wave to elicit a back-scattering response from the EH-capable device, and the third slot type may be for provision of a continuous wave for energy-harvesting at the EH-capable device.

In some examples of the method, first network node, apparatuses, and non-transitory computer-readable medium described herein, the at least one of the first grant or the second grant may be indicative of at least one of a first quantity of the first slot type in the communication resource, a second quantity of the second slot type in the communication resource, or a third quantity of the third slot type in the communication resource.

In some examples of the method, first network node, apparatuses, and non-transitory computer-readable medium described herein, the at least one of the first grant or the second grant may be indicative of at least one of a first time offset between slots of the first slot type and the second slot type, a second time offset between slots of the second slot type and the third slot type, or a third time offset between slots of the first slot type and the third slot type.

In some examples of the method, first network node, apparatuses, and non-transitory computer-readable medium described herein, at least one of the first time offset, the second time offset, or the third time offset may be based on a capability of at least one of the second network node, the third network node, or the EH-capable device.

In some examples of the method, first network node, apparatuses, and non-transitory computer-readable medium described herein, the first grant and the second grant may be transmitted via a group common DCI that may be transmitted to both the second network node and the third network node and the group common DCI indicates the second network node and the third network node from a set of multiple network nodes.

In some examples of the method, first network node, apparatuses, and non-transitory computer-readable medium described herein, indication of the second network node and the third network node in the group common DCI may be via a set of radio network temporary identifiers associated with the second network node and the third network node, a search space in which the group common DCI may be transmitted, or one or more bits in a field of the group common DCI.

Some examples of the method, first network node, apparatuses, and non-transitory computer-readable medium described herein may further include operations, features, means, or instructions for transmitting to the second network node and the third network node, control information that may be indicative of the EH-capable device, where the control information includes one or more of a type of the EH-capable device, an indication of the EH-capable device, a geographic zone of the EH-capable device, a sensor type included with the EH-capable device, a priority associated with the EH-capable device, or a quality-of-service of data associated with the EH-capable device.

In some examples of the method, first network node, apparatuses, and non-transitory computer-readable medium described herein, receiving the scheduling request may include operations, features, means, or instructions for receiving the scheduling request from the second network node.

In some examples of the method, first network node, apparatuses, and non-transitory computer-readable medium described herein, receiving the scheduling request may include operations, features, means, or instructions for receiving the scheduling request from the third network node.

In some examples of the method, first network node, apparatuses, and non-transitory computer-readable medium described herein, the scheduling request includes control information that may be indicative of at least one of a type of the EH-capable device, a priority associated with the EH-capable device, a requested duration of the communication resource, latency information associated with backscattering at the EH-capable device, a geographic zone of the EH-capable device, a set of network nodes capable of receiving the backscattering, a set of network nodes capable of interrogating the EH-capable device, a processing capability of the second network node, and a processing capability of the third network node.

A method for wireless communications at a first network node is described. The method may include receiving, from a second network node, a grant that schedules a communication resource for reception of a backscatter response from an EH-capable device, where the backscatter response is responsive to a transmission from a third network node to the EH-capable device and receiving the backscatter response via the communication resource in accordance with the grant.

A first network node for wireless communications is described. The first network node may include a memory; and at least one processor coupled to the memory. The at least one processor is configured to receive, from a second network node, a grant that schedules a communication resource for reception of a backscatter response from an EH-capable device, where the backscatter response is responsive to a transmission from a third network node to the EH-capable device and receive the backscatter response via the communication resource in accordance with the grant.

Another apparatus for wireless communications at a first network node is described. The apparatus may include means for receiving, from a second network node, a grant that schedules a communication resource for reception of a backscatter response from an EH-capable device, where the backscatter response is responsive to a transmission from a third network node to the EH-capable device and means for receiving the backscatter response via the communication resource in accordance with the grant.

A non-transitory computer-readable having code for wireless communications stored thereon is described. The code, when executed by a first network node, causes the first network node to receive, from a second network node, a grant that schedules a communication resource for reception of a backscatter response from an EH-capable device, where the backscatter response is responsive to a transmission from a third network node to the EH-capable device and receive the backscatter response via the communication resource in accordance with the grant.

In some examples of the method, first network node, apparatuses, and non-transitory computer-readable medium described herein, the grant may be DCI configured to activate a CG occasion for the first network node and the CG occasion may be the communication resource.

In some examples of the method, first network node, apparatuses, and non-transitory computer-readable medium described herein, the DCI indicates a quantity of slots as a duration for the CG occasion.

Some examples of the method, first network node, apparatuses, and non-transitory computer-readable medium described herein may further include operations, features, means, or instructions for receiving, prior to reception of the grant, an indication of one or more candidate durations of the CG occasion, where the quantity of slots indicated in the DCI as the duration of the CG occasion may be a designated one of the one or more candidate durations.

In some examples of the method, first network node, apparatuses, and non-transitory computer-readable medium described herein, the grant may be indicative of a quantity of slots for the reception.

In some examples of the method, first network node, apparatuses, and non-transitory computer-readable medium described herein, the grant may be indicative of a division of the communication resource into a set of multiple slot types, the set of multiple slot types including at least one of a first slot type, a second slot type, or a third slot type and the first slot type may be for provision of command information to the EH-capable device, the second slot type may be for provision of a continuous wave to elicit a back-scattering response from the EH-capable device, and the third slot type may be for provision of a continuous wave for energy-harvesting at the EH-capable device.

In some examples of the method, first network node, apparatuses, and non-transitory computer-readable medium described herein, the grant may be indicative of at least one of a first quantity of the first slot type in the communication resource, a second quantity of the second slot type in the communication resource, or a third quantity of the third slot type in the communication resource.

In some examples of the method, first network node, apparatuses, and non-transitory computer-readable medium described herein, the grant may be indicative of at least one of a first time offset between slots of the first slot type and the second slot type, a second time offset between slots of the second slot type and the third slot type, or a third time offset between slots of the first slot type and the third slot type.

In some examples of the method, first network node, apparatuses, and non-transitory computer-readable medium described herein, at least one of the first time offset, the second time offset, or the third time offset may be based on a capability of at least one of the third network node, the first network node, or the EH-capable device.

Some examples of the method, first network node, apparatuses, and non-transitory computer-readable medium described herein may further include operations, features, means, or instructions for receiving, during a slot of the second slot type, a synchronization signal indicative of a periodicity of the transmission.

In some examples of the method, first network node, apparatuses, and non-transitory computer-readable medium described herein, the grant may be received via a group common DCI and the group common DCI indicates the first network node from a set of multiple network nodes.

In some examples of the method, first network node, apparatuses, and non-transitory computer-readable medium described herein, indication of the first network node in the group common DCI may be via a set of radio network temporary identifiers associated with the first network node, a search space in which the group common DCI may be transmitted, or one or more bits in a field of the group common DCI.

Some examples of the method, first network node, apparatuses, and non-transitory computer-readable medium described herein may further include operations, features, means, or instructions for receiving, from the second network node, control information that may be indicative of the EH-capable device, where the control information includes one or more of a type of the EH-capable device, an indication of the EH-capable device, a geographic zone of the EH-capable device, a sensor type included with the EH-capable device, a priority associated with the EH-capable device, or a quality-of-service of data associated with the EH-capable device.

Some examples of the method, first network node, apparatuses, and non-transitory computer-readable medium described herein may further include operations, features, means, or instructions for transmitting, to the second network node, a scheduling request for the transmission, where the grant may be responsive to the scheduling request.

In some examples of the method, first network node, apparatuses, and non-transitory computer-readable medium described herein, the scheduling request includes control information that may be indicative of at least one of a type of the EH-capable device, a priority associated with the EH-capable device, a requested duration of the communication resource, latency information associated with backscattering at the EH-capable device, a geographic zone of the EH-capable device, a set of network nodes capable of interrogating the EH-capable device, and a processing capability of the first network node.

A method for wireless communications at a first network node is described. The method may include receiving, from a second network node, a grant that schedules a communication resource for a transmission, where the transmission is from the first network node to an EH-capable device configured to perform backscattering and communicating, to the EH-capable device, the transmission via the communication resource in accordance with the grant.

A first network node for wireless communications is described. The first network node may include a memory; and at least one processor coupled to the memory. The at least one processor is configured to receive, from a second network node, a grant that schedules a communication resource for a transmission, where the transmission is from the first network node to an EH-capable device configured to perform backscattering and communicating, to the EH-capable device, the transmission via the communication resource in accordance with the grant.

Another apparatus for wireless communications at a first network node is described. The apparatus may include means for receiving, from a second network node, a grant that schedules a communication resource for a transmission, where the transmission is from the first network node to an EH-capable device configured to perform backscattering and means for communicating, to the EH-capable device, the transmission via the communication resource in accordance with the grant.

A non-transitory computer-readable having code for wireless communications stored thereon is described. The code, when executed by a first network node, causes the first network node to receive, from a second network node, a grant that schedules a communication resource for a transmission, where the transmission is from the first network node to an EH-capable device configured to perform backscattering and communicating, to the EH-capable device, the transmission via the communication resource in accordance with the grant.

In some examples of the method, first network node, apparatuses, and non-transitory computer-readable medium described herein, the grant may be DCI configured to activate a CG occasion for the first network node and the CG occasion may be the communication resource.

In some examples of the method, first network node, apparatuses, and non-transitory computer-readable medium described herein, the DCI indicates a quantity of slots as a duration for the CG occasion.

Some examples of the method, first network node, apparatuses, and non-transitory computer-readable medium described herein may further include operations, features, means, or instructions for receiving, prior to reception of the grant, an indication of one or more candidate durations of the CG occasion, where the quantity of slots indicated in the DCI as the duration of the CG occasion may be a designated one of the one or more candidate durations.

In some examples of the method, first network node, apparatuses, and non-transitory computer-readable medium described herein, the grant may be indicative of a quantity of slots for the transmission.

In some examples of the method, first network node, apparatuses, and non-transitory computer-readable medium described herein, the grant may be indicative of a division of the communication resource into a set of multiple slot types, the set of multiple slot types including at least one of a first slot type, a second slot type, or a third slot type and the first slot type may be for provision of command information to the EH-capable device, the second slot type may be for provision of a continuous wave to elicit a back-scattering response from the EH-capable device, and the third slot type may be for provision of a continuous wave for energy-harvesting at the EH-capable device.

In some examples of the method, first network node, apparatuses, and non-transitory computer-readable medium described herein, the grant may be indicative of at least one of a first quantity of the first slot type in the communication resource, a second quantity of the second slot type in the communication resource, or a third quantity of the third slot type in the communication resource.

In some examples of the method, first network node, apparatuses, and non-transitory computer-readable medium described herein, the grant may be indicative of at least one of a first time offset between slots of the first slot type and the second slot type, a second time offset between slots of the second slot type and the third slot type, or a third time offset between slots of the first slot type and the third slot type.

In some examples of the method, first network node, apparatuses, and non-transitory computer-readable medium described herein, at least one of the first time offset, the second time offset, or the third time offset may be based on a capability of at least one of the first network node, a third network node, or the EH-capable device.

Some examples of the method, first network node, apparatuses, and non-transitory computer-readable medium described herein may further include operations, features, means, or instructions for transmitting, during a slot of the second slot type, a synchronization signal indicative of a periodicity of the transmission.

In some examples of the method, first network node, apparatuses, and non-transitory computer-readable medium described herein, the grant may be received via a group common DCI and the group common DCI indicates the first network node from a set of multiple network nodes.

In some examples of the method, first network node, apparatuses, and non-transitory computer-readable medium described herein, indication of the first network node in the group common DCI may be via a set of radio network temporary identifiers associated with the first network node, a search space in which the group common DCI may be transmitted, or one or more bits in a field of the group common DCI.

Some examples of the method, first network node, apparatuses, and non-transitory computer-readable medium described herein may further include operations, features, means, or instructions for receiving, from the second network node, control information that may be indicative of the EH-capable device, where the control information includes one or more of a type of the EH-capable device, an indication of the EH-capable device, a geographic zone of the EH-capable device, a sensor type included with the EH-capable device, a priority associated with the EH-capable device, or a quality-of-service of data associated with the EH-capable device.

Some examples of the method, first network node, apparatuses, and non-transitory computer-readable medium described herein may further include operations, features, means, or instructions for transmitting, to the second network node, a scheduling request for the transmission, where the grant may be responsive to the scheduling request.

In some examples of the method, first network node, apparatuses, and non-transitory computer-readable medium described herein, the scheduling request includes control information that may be indicative of at least one of a type of the EH-capable device, a priority associated with the EH-capable device, a requested duration of the communication resource, latency information associated with backscattering at the EH-capable device, a geographic zone of the EH-capable device, set of network nodes capable of receiving the backscattering, and a processing capability of the first network node.

### BRIEF DESCRIPTION OF THE DRAWINGS

FIG. 1 shows an example of a wireless communications system that supports techniques for scheduling communication resources for backscatter modulation in accordance with one or more aspects of the present disclosure.

FIG. 2 shows an example of a wireless communications system that supports techniques for scheduling communication resources for backscatter modulation in accordance with one or more aspects of the present disclosure.

FIG. 3 shows an example of a timing diagram that supports techniques for scheduling communication resources for backscatter modulation in accordance with one or more aspects of the present disclosure.

FIG. 4 shows an example of a process flow that supports techniques for scheduling communication resources for backscatter modulation in accordance with one or more aspects of the present disclosure.

FIGS. 5 and 6 show block diagrams of devices that support techniques for scheduling communication resources for backscatter modulation in accordance with one or more aspects of the present disclosure.

FIG. 7 shows a block diagram of a communications manager that supports techniques for scheduling communication resources for backscatter modulation in accordance with one or more aspects of the present disclosure.

FIG. 8 shows a diagram of a system including a device that supports techniques for scheduling communication resources for backscatter modulation in accordance with one or more aspects of the present disclosure.

FIGS. 9 and 10 show block diagrams of devices that support techniques for scheduling communication resources for backscatter modulation in accordance with one or more aspects of the present disclosure.

FIG. 11 shows a block diagram of a communications manager that supports techniques for scheduling communication resources for backscatter modulation in accordance with one or more aspects of the present disclosure.

FIG. 12 shows a diagram of a system including a device that supports techniques for scheduling communication resources for backscatter modulation in accordance with one or more aspects of the present disclosure.

FIGS. 13 through 15 show flowcharts illustrating methods that support techniques for scheduling communication resources for backscatter modulation in accordance with one or more aspects of the present disclosure.

### DETAILED DESCRIPTION

Some wireless communications systems may include passive devices, such as radio frequency identifier (RFID) tags, to perform operations such as location tracking and identification. Passive devices may receive power from transmissions by other devices, and thus may be referred to as energy harvesting (EH)-capable devices. For example, an interrogating device may transmit a continuous wave (CW) signal to the passive device, and the passive device may use energy from the CW signal to activate radio frequency components and “backscatter” the CW signal, which may be received by the interrogating device or another device. In some cases, RFID processing may involve bi-static communications that include the EH-capable device and multiple network nodes such as a source network node (e.g., an interrogating device such as a user equipment (UE)) and a reader network node (e.g., a reader device such as another UE that receives the backscatter response). The source network node may transmit an interrogating signal to the EH-capable device for the EH-capable device to backscatter the signal. The reader network node may receive and decode the backscatter response to the signal. Coordination of such bi-static communication is currently not defined.

Upon reception of a scheduling request by a scheduling network node (e.g., a network entity) from either a source network entity or a reader network entity, the scheduling network node may schedule communication resources for bi-static communications that includes the EH-capable device. In a bi-static EH-capable device scenario, a scheduling request from the reader network node requests a transmission from another entity (e.g., the source network node) to interrogate the EH-capable device and also requests a corresponding monitoring occasion for the reader network node. In another example, a scheduling request from the source network entity requests a communication resource for a transmission to interrogate the EH-capable device and also requests a corresponding monitoring occasion for another entity (the reader network entity) to receive a backscattered response to the interrogating transmission from the EH-capable device.

Thus, upon receipt of the scheduling request, the scheduling network node may transmit two grants. One of the grants is to the source network node and is for a transmission from the source network node to the EH-capable device. The other grant is to the reader network node and is for reception of a backscatter response from the EH-capable device to the transmission from the source network entity. In some aspects, the first and second grants may be downlink control information (DCI) activating configured grant (CG) occasions for the source and reader network nodes. The first grant and the second grant may indicate a quantity of slots allocated to the transmission and to the reception, including slots for the signaling of command information to the EH-capable device, slots for a CW transmission from the source network entity to the EH-capable device, and slots for reading a backscattered signal at the reader network entity. The source network node may communicate a transmission to the EH-capable device in accordance with the first grant, and the reader network node may receive the backscatter response to the transmission from the EH-capable device in accordance with the second grant.

Aspects of the disclosure are initially described in the context of wireless communications systems. Aspects of the disclosure are further illustrated by and described with reference to timing diagrams, process flows, apparatus diagrams, system diagrams, and flowcharts that relate to techniques for scheduling communication resources for backscatter modulation.

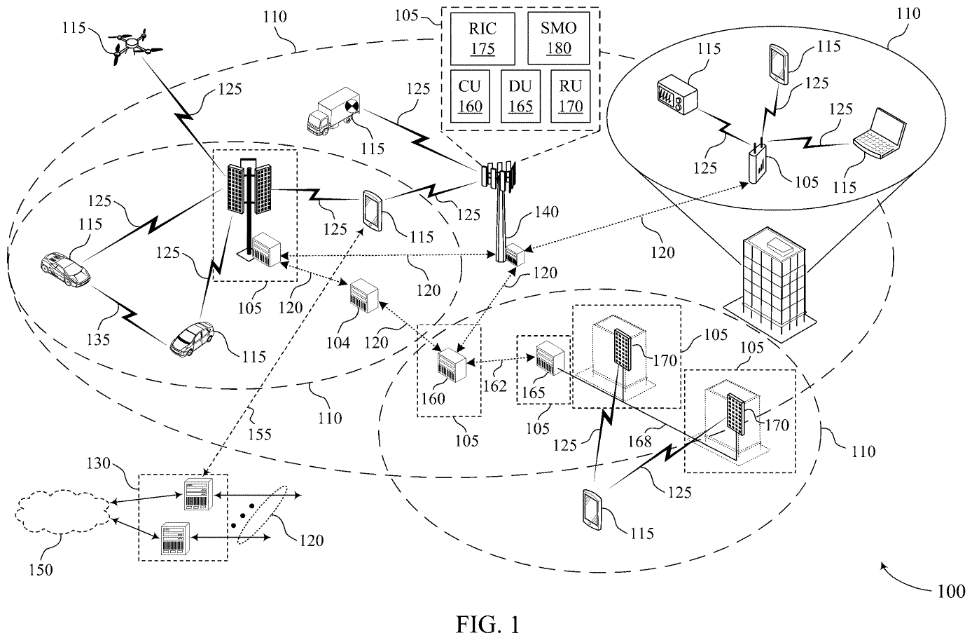

FIG. 1 shows an example of a wireless communications system 100 that supports techniques for scheduling communication resources for backscatter modulation in accordance with one or more aspects of the present disclosure. The wireless communications system 100 may include one or more network entities 105, one or more UEs 115, and a core network 130. In some aspects, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some aspects, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some aspects, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some aspects, network entities 105 may communicate with one another via a backhaul communication link 120 (e.g., in accordance with an X2, Xn, or other interface protocol) either directly (e.g., directly between network entities 105) or indirectly (e.g., via a core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3(L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1(L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some aspects, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for scheduling communication resources for backscatter modulation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some aspects, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some aspects, the wireless communications system 100 may include network entities 105 or UEs 115 that support concurrent communications using carriers associated with multiple carrier bandwidths. In some aspects, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δƒ) and a cyclic prefix. A carrier may be divided into one or more BWPs having the same or different numerologies. In some aspects, a UE 115 may be configured with multiple BWPs. In some aspects, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some aspects of the wireless communications systems 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some aspects, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some aspects, a network entity 105 (e.g., a base station 140, an RU 170) may be movable and therefore provide communication coverage for a moving coverage area 110. In some aspects, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some aspects, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some aspects, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some aspects, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be configured to support communicating directly with other UEs 115 via a device-to-device (D2D) communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some aspects, one or more UEs 115 of such a group may be outside the coverage area 110 of a network entity 105 or may be otherwise unable to or not configured to receive transmissions from a network entity 105. In some aspects, groups of the UEs 115 communicating via D2D communications may support a one-to-many (1:M) system in which each UE 115 transmits to each of the other UEs 115 in the group. In some aspects, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some aspects, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some aspects, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some aspects, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some aspects, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some aspects, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some aspects, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may include passive devices, such as RFID tags, to perform operations such as location tracking and identification. Passive devices may receive power from transmissions by other devices, and thus may be referred to as EH-capable devices. Some passive devices may not have their own power sources. An interrogating device may transmit a CW signal to a passive device, and the passive device may use energy from the CW signal to activate radio frequency components and “backscatter” the CW signal, which may be received by the interrogating device or another device.

For example, a passive device may include a power rectifier, a forward-link demodulation element, a logic element/controller, memory, and a modulator (e.g., either a phase shift key modulator or an amplitude shift key modulator). An RFID reader device may include a transmitter and a transmitting antenna for transmission of an interrogating signal, a receiver and a receiver antenna for reception of a backscatter response, a baseband processor for processing the received backscatter response, and a leaking carrier canceller for canceling leakage between the transmitted interrogating signal and the backscatter response. In some aspects, an RFID reader device may transmit a CW signal to power up a passive device and then may transmit modulated commands (e.g., having values of “1” and “0”). The passive device may absorb the power transmitted by the RFID reader device, and may reflect a backscatter response. The backscatter response may convey information from the memory of the passive device modulated using the modulator. In some aspects, an RFID reader device may be a UE 115 or a network entity 105.

In some cases, RFID processing may involve bi-static communications that includes the EH-capable device and multiple network nodes such as a source network node (e.g., a UE 115 that transmits an interrogating signal) and a reader network node (e.g., a UE 115 that receives the backscatter response). The source network node may transmit an interrogating signal (e.g., a CW signal) to the EH-capable device for the EH-capable device to backscatter the signal. The reader network node may receive and decode the backscatter response to the signal.

Upon reception of a scheduling request by a scheduling network node (e.g., a network entity 105) from either a source network node or a reader network node, the scheduling network node may schedule communication resources for bi-static communications that includes the EH-capable device. In a bi-static EH-capable device scenario, a scheduling request from the reader network node requests a transmission from another entity (e.g., the source network node) to interrogate the EH-capable device and also requests a corresponding monitoring occasion for the reader network node. In another example, a scheduling request from the source network entity requests a communication resource for a transmission to interrogate the EH-capable device and also requests a corresponding monitoring occasion for another entity (the reader network node) to receive a backscattered response to the interrogating transmission from the EH-capable device. Thus, upon receipt of the scheduling request, the scheduling network node may transmit two grants. One of the grants is to the source network node and is for a transmission from the source network entity to the EH-capable device. The other grant is to the reader network node and is for reception of a backscatter response from the EH-capable device to the transmission from the source network entity. In some aspects, the first and second grants may be DCI activating CG occasions for the source and reader network nodes. The first grant and the second grant may indicate a quantity of slots allocated to the transmission and to the reception, including slots for the signaling of command information to the EH-capable device, slots for a CW transmission from the source network entity to the EH-capable device, and slots for reading a backscattered signal at the reader network entity. The source network node may communicate a transmission to the EH-capable device in accordance with the first grant, and the reader network node may receive the backscatter response to the transmission from the EH-capable device in accordance with the second grant.

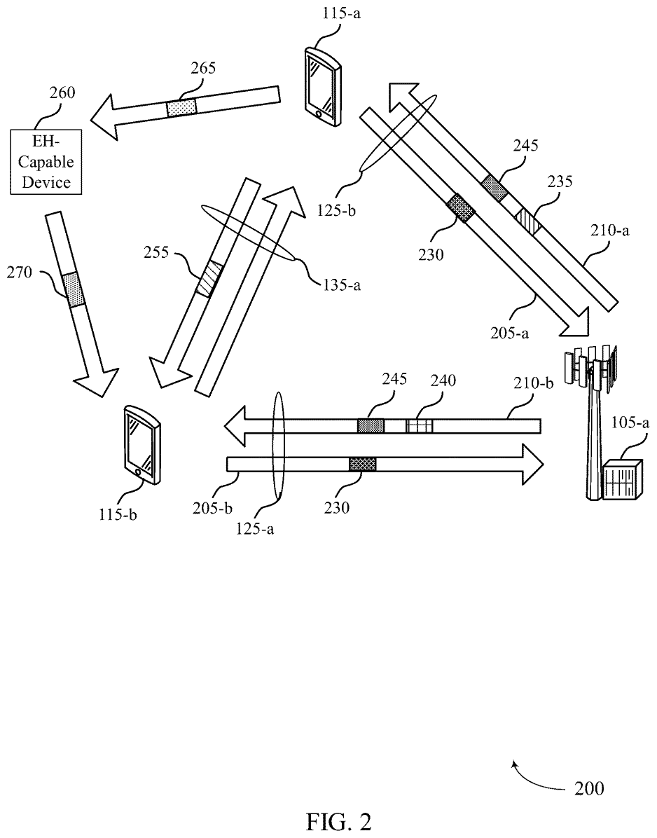

FIG. 2 shows an example of a wireless communications system 200 that supports techniques for scheduling communication resources for backscatter modulation in accordance with one or more aspects of the present disclosure. The wireless communications system 200 may implement aspects of or may be implemented by aspects of the wireless communications system 100. For example, the wireless communications system 200 includes a UE 115-a and a UE 115-b, which may be examples of a UE 115 described with respect to FIG. 1. The wireless communications system 200 also includes a network entity 105-a, which may be an example of a network entity 105 as described with respect to FIG. 1.

The UE 115-a may communicate with the network entity 105-a using a communication link 125-a, and the UE 115-b may communicate with the network entity 105-a using a communication link 125-b. The communication link 125-a may be an example of an NR or LTE link between the UE 115-a and the network entity 105-a. The communication link 125-b may be an example of an NR or LTE link between the UE 115-b and the network entity 105-a. The communication link 125-a and the communication link 125-b may include bi-directional links that enable both uplink and downlink communications. For example, the UE 115-a may transmit uplink signals 205-a (e.g., uplink transmissions), such as uplink control signals or uplink data signals, to the network entity 105-a using the communication link 125-a and the network entity 105-a may transmit downlink signals 210-a (e.g., downlink transmissions), such as downlink control signals or downlink data signals, to the UE 115-a using the communication link 125-a. The UE 115-b may transmit uplink signals 205-b (e.g., uplink transmissions), such as uplink control signals or uplink data signals, to the network entity 105-a using the communication link 125-b and the network entity 105-a may transmit downlink signals 210-b (e.g., downlink transmissions), such as downlink control signals or downlink data signals, to the UE 115-b using the communication link 125-b.

The UE 115-a may communicate with the UE 115-b using a communication link 135-a, which may be an example of a communication link 135 as described herein. For example, the communication link 135-a may be a sidelink communication link and may support bidirectional communications between the UE 115-a and the UE 115-b.

In some aspects, the wireless communications system 200 may support bi-static communications involving an EH-capable device 260. For example, the EH-capable device 260 may be an RFID device or a passive device as described herein. In some aspects, information may be modulated onto a backscatter response 270 using amplitude shift keying (ASK). To use ASK, backscatter reflection is turned on to transmit an information bit “1” and backscatter reflection is turned off to transmit an information bit “0.” For example, a transmission 265 from the UE 115-a to the EH-capable device 260 may be denoted as x(n). The information bits for the EH-capable device to backscatter may be given by s(n)∈{0,1}. Accordingly, the backscatter response 270 received by the UE 115-b may be given by y(n)=(h_{D1D2}(n)+σ_{ƒ}h_{D1T}(n)h_{TD2}(n)s(n))x(n)+noise, where h_{D1D2}(n) represents the channel between the UE 115-a and the UE 115-b, hp17(n) represents the channel between the UE 115-a and the EH-capable device 260, h_{TD2}(n) represents the channel between the EH-capable device 260 and the UE 115-b, and of denotes the reflection coefficient of the EH-capable device 260. When s(n)=0, reflection is switched off at the EH-capable device 260, so the UE 115-b receives only the direct link signal (e.g., y(n)=h_{D1D2}(n)x(n)+noise. When s(n)=1, reflection is switched on at the EH-capable device 260, so the UE 115-b receives the superposition of both the direct link signal and the backscatter link signal (e.g., y(n)=(h_{D1D2}(n)+σ_{ƒ}h_{D1T}(n)h_{TD2}(n)s(n))x(n)+noise).

In some aspects, the UE 115-a may transmit during both uplink and downlink slots to complete an RFID tag processing session. During an RFID processing session, EH-capable device 260 (or multiple EH-capable devices) may be read and/or configured with an updated configuration (e.g., change of parameters, time to start response during a session, adjustment of a threshold, different power configuration, or different beam configuration, for either the current communication session or a next communication session).

In sidelink mode 1, the network (e.g., the network entity 105-a) may schedule communication resources for sidelink communications between UEs 115 (e.g., the UE 115-a and the UE 115-b). For example, a UE 115 (e.g., the UE 115-a and the UE 115-b) may transmit a scheduling request 230. In response to the scheduling request 230, the network entity 105-a may transmit control signaling allocating a dynamic grant or a CG for the requesting UE 115. The receiving UE 115 (e.g., the UE 115-b) may not receive an indication of the dynamic grant or the allocated CG. The receiving UE 115 (e.g., the UE 115-b) may monitor each transmission and determine: 1) a new transmission based on current sidelink control information (SCI) and/or physical sidelink shared channel (PSSCH) decoding; or 2) a retransmission based on: i) the SCI of the current transmission which declares the receive time/frequency offsets with respect to the current transmission; or ii) decoding the SCI at the time of retransmission.

In bi-static communications involving an EH-capable device 260, the transmitting UE 115 (e.g., the UE 115-a) may communicate a transmission 265 to the EH-capable device 260 that may include a modulated command and/or an unmodulated signal. The EH-capable device 260 may backscatter the unmodulated signal with the payload of the EH-capable device 260 modulated onto the backscatter response 270. The receiving UE 115 (e.g., the UE 115-b) may receive the backscatter response 270. Such bi-static communications may involve more than 1 slot (e.g., the EH-capable device 260 may use 1 slot in 30 kHz subcarrier spacing (SCS) or 0.5 ms for powering up). Such bi-static communications may involve saving power at the receiving UE 115 (e.g., the UE 115-b by configuring the CG occasions beforehand so that the receiving UE 115 does not perform blind decoding or so that the receiving UE 115 may determine the allocation of the CG occasion is for reception of the backscatter response 270 so that the receiving UE 115 does not use the CG occasion for transmission. Such bi-static communications may involve either the sidelink interface, the Uu interface (e.g., access interface for communications between the UE 115 and the network entity 105-a), or a new interface.

Accordingly, as described herein, the network entity 105-a may transmit a first grant 235 that schedules a communication resource for a transmission 265 from the UE 115-a to the EH-capable device 260. The network entity 105-a may transmit a second grant 240 that schedules the communication resource for the UE 115-b for reception of a backscatter response 270 from the EH-capable device 260 to the transmission 265. The UE 115-a may subsequently communicate the transmission 265 in accordance with the first grant 235, and the UE 115-b may receive the backscatter response 270 to the transmission 265 in accordance with the second grant 240. In some aspects, the network entity 105-a may transmit the first grant 235 and the second grant 240 in response to a scheduling request 230 from either the UE 115-a or the UE 115-b.

In some aspects, the first grant 235 may be an uplink CG (e.g., the first grant 235 may activate an uplink CG occasion), and the second grant 240 may be a downlink CG (e.g., the second grant 240 may activate a downlink CG occasion similarly to semi-persistent scheduling except the reception is from another UE/EH-capable device instead of the network entity). In some aspects, the first grant 235 may be a sidelink transmission CG (e.g., the first grant 235 may activate a sidelink transmission CG occasion), and the second grant 240 may be a sidelink reception CG (e.g., the second grant 240 may activate a sidelink reception CG occasion) which is different from direct sidelink communications as in direct sidelink communications, there are no sidelink reception CGs and instead the receiving UE 115 decodes SCI to determine whether a given transmission is meant for that UE 115.

In some aspects, a group common DCI may activate a transmit CG occasion for the UE 115-a and a receive CG occasion for the UE 115-b (e.g., the first grant 235 and the second grant 240 may be conveyed by a group common DCI). RRC 245 may configure the transmit CGs and the receive CGs. Such transmit CGs and the receive CGs may be commonly used by a pool of source UEs 115 (e.g., interrogating UEs 115 such as the UE 115-a) and reader UEs 115 (e.g., reader UEs 115 such as the UE 115-b), and accordingly a common configuration may be used. DCI may then indicate the UEs 115 that from the pool(s) that are the source UE 115 and the reader UE 115 (e.g., via radio network temporary identifiers (RNTIs) in the DCI, the search space of the DCI, or fields/bits in the DCI). In some aspects, the network entity 105-a may indicate the pair of UEs 115 (e.g., the UE 115-a and the UE 115-b), and the UE 115-a and the UE 115-b may negotiate which is the source and which is the reader (e.g., which will communicate the transmission 265 and which will receive the backscatter response 270) using the communication link 135-a. In some aspects, the UE 115-a and/or the UE 115-b may adjust parameters (e.g., the CG size) using the sidelink interface (e.g., the communication link 135-a) or the Uu interface (e.g., using the communication link 125-a or the communication link 125-b to negotiate with the network entity 105-a via DCI, uplink control information (UCI) or reference signal modulated signals). In some aspects, the first grant 235 and the second grant 240 may be unicast DCIs that activate a transmit CG occasion for the UE 115-a and a receive CG occasion for the UE 115-b, respectively.

In some aspects, the network entity 105-a may indicate in a CG configuration which EH-capable device 260 should be served by the CG (e.g., via class/type, ID, the zone/position of the EH-capable device 260, the communication/sensor type of the EH-capable device 260, priority of data associated with the EH-capable device 260, and/or the quality of service (QoS) of data associated with the EH-capable device 260). In some aspects, the UEs 115 may use the CGs for their own traffic (e.g., sidelink communications) if the UEs have data to transmit with the same priority as indicated by the CG configuration.

In some aspects, the UE 115-a may transmit, to the UE 115-b, a synchronization signal 255 indicative of the periodicity of the transmission 265.

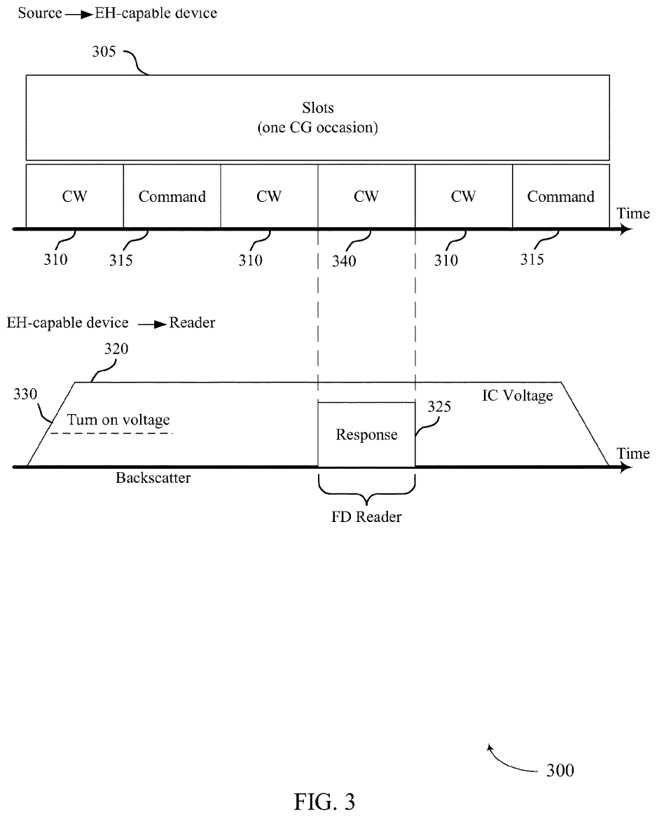

FIG. 3 shows an example of a timing diagram 300 that supports techniques for scheduling communication resources for backscatter modulation in accordance with one or more aspects of the present disclosure. The timing diagram 300 may implement or may be implemented by aspects of the wireless communications system 100 or the wireless communications system 200.

In backscatter communications, a source device (e.g., the UE 115-a of FIG. 2) may perform a talks-first procedure. The source device may transmit a CW 310 in a first slot (e.g., for a first duration (e.g., 400 μs)), which the EH-capable device 260 receives. The EH-capable device 260 receives the CW 310 and reaches the turn-on voltage 330 of the EH-capable device 260. Once the EH-capable device 260 reaches the turn-on voltage 330, the source device may transmit commands 315 (e.g., modulated signals) to the EH-capable device 260 which may include information for the EH-capable device 260. The receive power of the command 315 at the EH-capable device 260 may be greater than −20 dBm to maintain the voltage at the EH-capable device 260 above the turn-on voltage 330 (e.g., at a voltage 320 sufficient to power the integrated circuit (IC) of the EH-capable device 260). The source device may subsequently transmit another CW 310 in the next slot to maintain the “on” state of the EH-capable device 260. The source device may subsequently transmit a CW 340 in the next slot for tag modulation, which the EH-capable device 260 may backscatter as a backscatter response 325. A reader device (e.g., the UE 115-b of FIG. 2) may receive the backscatter response 325. The command 315 may indicate that the slot including the CW 340 will be used for backscattering. The source device may transmit additional CWs 310 for maintaining the “on” state at the EH-capable device and/or additional commands 315 in subsequent slots.

Accordingly, a CG occasion 305 for bi-static communications involving an EH-capable device 260 may include multiple slots. RRC signaling or the first and second grants (e.g., the first grant 235 and the second grant 240 of FIG. 2) may accordingly define the size of the CG occasion 305 in the quantity of slots. For example, the first and second grants to the source and reader UEs 115, respectively, may indicate the quantity of slots of a CG occasion 305 that will be used for bi-static communications involving an EH-capable device 260. In some aspects, the quantity of slots may be configured or updated via the DCI(s) that activates the CG occasion 305 or the reactivation DCI that activates the CG occasion 305. In some aspects, RRC signaling may configure a set of candidate quantities of slots of the CG occasion 305 that will be used for bi-static communications involving an EH-capable device 260, and the DCI(s) that activates the CG occasion 305 may select one of the candidate quantities of slots.

In some aspects, the quantity of slots/subslots/symbol for commands 315 (e.g., modulated CWs for the EH-capable device 260 to process), the quantity slots/subslots/symbols for CWs 340 for backscattering, and the quantity of slots/subslots/symbols for CWs 310 for powering up the EH-capable device 260 may be defined within the CG occasion 305. A gap between the different types of signals (e.g., to switch radio frequency (RF) or communication direction) between these types of signals (e.g., CWs 340, CWs 310, and commands 315) may also be defined. The gap may depend on the capability of the source (e.g., the UE 115-a of FIG. 2), the reader (e.g., the UE 115-b of FIG. 2), and/or the EH-capable device 260 (including the class of EH-capable device).

In some aspects, the command 315 may include a preamble or synchronization signal. In some aspects, the synchronization signal may be a separate synchronization signal. In some aspects, the backscatter response 325 may include a synchronization signal. In some aspects, the command 315 may include a general synchronization signal with a periodicity that assists in synchronizing the source and reader devices and/or the EH-capable device 260. In some aspects, some communication resources may be reserved for the source and reader devices to communicate (e.g., for communication between the UE 115-a and the UE 115-b via the communication link 135-a of FIG. 2).

In some aspects, the waveforms, coding type, and modulation type may be signaled to the EH-capable device 260 prior to transmission in the CG occasion 305. For example, the waveforms, coding type, and modulation type may be signaled to the EH-capable device 260 may be indicated to the EH-capable device 260 from the network or from either the source or the reader devices. For example, knowledge of the waveforms, coding type, and modulation type may be used by the EH-capable device 260 to decode the command 315 and the CW 340 for backscattering.

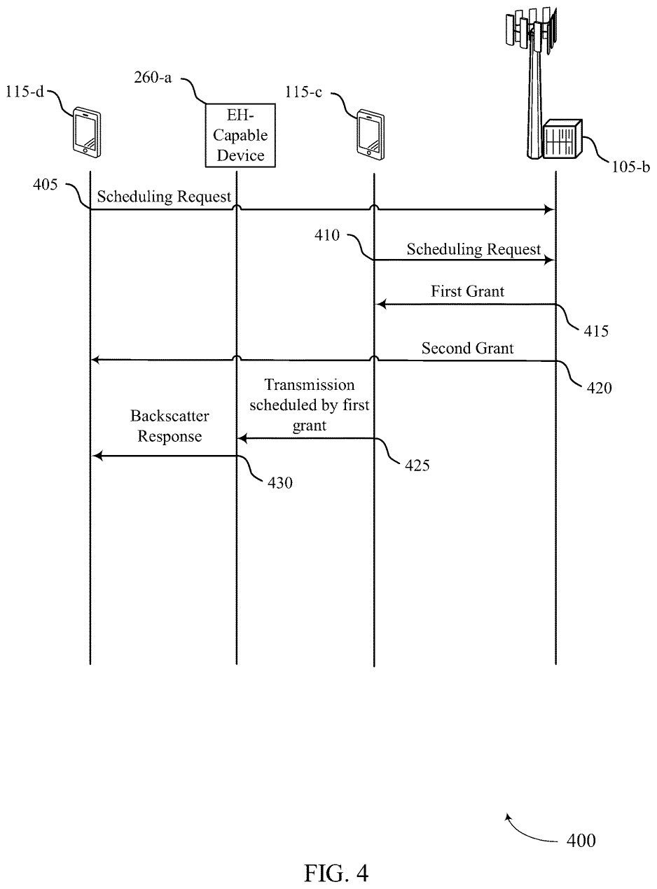

FIG. 4 shows an example of a process flow 400 that supports techniques for scheduling communication resources for backscatter modulation in accordance with one or more aspects of the present disclosure. The process flow 400 may include a first UE 115-c and a second UE 115-d, which may be examples of UEs 115, as described herein. The process flow 400 may also include a network entity 105-b, which may be an example of network entity 105, as described herein. The process flow 400 may also include an EH-capable device 260-a, which may be an example of an EH-capable device 260 as described herein.

In the following description of the process flow 400, the operations between the network entity 105-b, the first UE 115-c, the second UE 115-d, and the EH-capable device 260-a may be transmitted in a different order than the example order shown, or the operations performed by the network entity 105-b, the first UE 115-c, the second UE 115-d, and the EH-capable device 260-a may be performed in different orders or at different times. Some operations may also be omitted from the process flow 400, and other operations may be added to the process flow 400.

In some aspects, at 405, the second UE 115-d may transmit, to the network entity 105-b, a scheduling request. In some aspects, at 410, the first UE 115-c may transmit the scheduling request. The scheduling request may be for a transmission from the first UE 115-c to the EH-capable device 260-a, where the EH-capable device 260-a is configured to perform backscattering.

At 415, the network entity 105-b may transmit, to the first UE 115-c, a first grant based on the scheduling request, The first grant schedules a communication resource for the transmission from the first UE 115-c to the EH-capable device 260-a.

At 420, the network entity 105-b may transmit, to the second UE 115-d, a second grant based on the scheduling request. The second grant schedules the communication resource for reception of a backscatter response from the EH-capable device 260-a (e.g., a backscatter response to the transmission scheduled by the first grant).

At 425, the first UE 115-c may communicate, to the EH-capable device 260-a, the transmission in accordance with the first grant.

The EH-capable device 260-a may backscatter the transmission (e.g., may transmit a backscatter response to the transmission), and at 430, the second UE 115-d may receive the backscatter response in accordance with the second grant.

In some aspects, the first grant is a first DCI configured to activate a CG occasion for the first UE 115-c and the second grant is a second DCI configured to activate the CG occasion for the second UE 115-d. In such aspects, the communications resource may be the CG occasion. In some aspects, the first DCI and the second DCI may indicate a same quantity of slots as a duration of the CG occasion. In some aspects, prior to transmitting the first and second grants at 415 and 420, the network entity 105-b may transmit an indication of one or more candidate durations of the CG occasion, and the same quantity of slots indicated in the first DCI and in the second DCI as the duration of the CG occasion is a designated one of the one or more candidate durations.

In some aspects, the first grant is indicative of a first quantity of slots for the transmission and the second grant is indicative of a second quantity of slots for the reception.

In some aspects, at least one of the first grant or the second grant is indicative of a division of the communication resource into a set of multiple slot types, the set of multiple slot types including at least one of a first slot type, a second slot type, or a third slot type. The first slot type may be for provision of command information to the EH-capable device, the second slot type may be for provision of a CW to elicit a back-scattering response from the EH-capable device, and the third slot type may be for provision of a CW for energy-harvesting at the EH-capable device. In some aspects, the at least one of the first grant or the second grant is indicative of at least one of a first quantity of the first slot type in the communication resource, a second quantity of the second slot type in the communication resource, or a third quantity of the third slot type in the communication resource. In some aspects, the at least one of the first grant or the second grant is indicative of at least one of a first time offset between slots of the first slot type and the second slot type, a second time offset between slots of the second slot type and the third slot type, or a third time offset between slots of the first slot type and the third slot type. In some aspects, at least one of the first time offset, the second time offset, or the third time offset is based on a capability of at least one of the first UE 115-c, the second UE 115-d, or the EH-capable device. In some aspects, the first UE 115-c may transmit, to the second UE 115-d, during a slot of the second slot type, a synchronization signal indicative of a periodicity of the transmission.

In some aspects, the first grant and the second grant are transmitted via a group common DCI that is transmitted to both the first UE 115-c and the second UE 115-d, and the group common DCI indicates the first UE 115-c and the second UE 115-d from a set of multiple network nodes (e.g., a set of multiple UEs). In some aspects, indication of the first UE 115-c and the second UE 115-d in the group common DCI is via a set of RNTIs associated with the first UE 115-c and the second UE 115-d, a search space in which the group common DCI is transmitted, or one or more bits in a field of the group common DCI.

In some aspects, the network entity 105-b may transmit, to the first UE 115-c and the second UE 115-d, control information that is indicative of the EH-capable device. The control information may include one or more of a type of the EH-capable device, an indication of the EH-capable device, a geographic zone of the EH-capable device, a sensor type included with the EH-capable device, a priority associated with the EH-capable device, or a QoS of data associated with the EH-capable device.

In some aspects, the scheduling request at 405 may include control information that is indicative of at least one of a type of the EH-capable device, a priority associated with the EH-capable device, a requested duration of the communication resource, latency information associated with backscattering at the EH-capable device, a geographic zone of the EH-capable device, a set of network nodes capable of interrogating the EH-capable device, and a processing capability of the second UE 115-d.

In some aspects, the scheduling request at 410 may include control information that is indicative of at least one of a type of the EH-capable device, a priority associated with the EH-capable device, a requested duration of the communication resource, latency information associated with backscattering at the EH-capable device, a geographic zone of the EH-capable device, set of network nodes capable of receiving the backscattering, and a processing capability of the first UE 115-c.

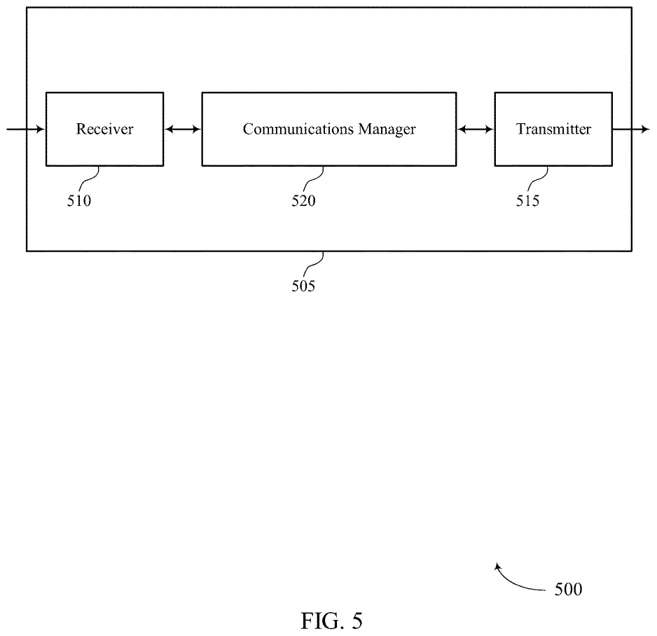

FIG. 5 shows a block diagram 500 of a device 505 that supports techniques for scheduling communication resources for backscatter modulation in accordance with one or more aspects of the present disclosure. The device 505 may be an example of aspects of a network entity 105 as described herein. The device 505 may include a receiver 510, a transmitter 515, and a communications manager 520. The device 505 may also include a processor. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some aspects, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some aspects, the transmitter 515 and the receiver 510 may be co-located in a transceiver, which may include or be coupled with a modem.

The communications manager 520, the receiver 510, the transmitter 515, or various combinations thereof or various components thereof may be examples of means for performing various aspects of techniques for scheduling communication resources for backscatter modulation as described herein. For example, the communications manager 520, the receiver 510, the transmitter 515, or various combinations or components thereof may support a method for performing one or more of the functions described herein.

In some aspects, the communications manager 520, the receiver 510, the transmitter 515, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some aspects, a processor and memory coupled with the processor may be configured to perform one or more of the functions described herein (e.g., by executing, by the processor, instructions stored in the memory).

Additionally, or alternatively, in some aspects, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some aspects, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a first network node in accordance with examples as disclosed herein. For example, the communications manager 520 may be configured as or otherwise support a means for receiving, from one of a second network node or a third network node, a scheduling request, where the scheduling request is for a transmission from the second network node to an EH-capable device configured to perform backscattering. The communications manager 520 may be configured as or otherwise support a means for transmitting, to the second network node, a first grant based on the scheduling request, where the first grant schedules a communication resource for the transmission. The communications manager 520 may be configured as or otherwise support a means for transmitting, to the third network node, a second grant based on the scheduling request, where the second grant schedules the communication resource for reception of a backscatter response from the EH-capable device.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for more efficient utilization of communication resources.

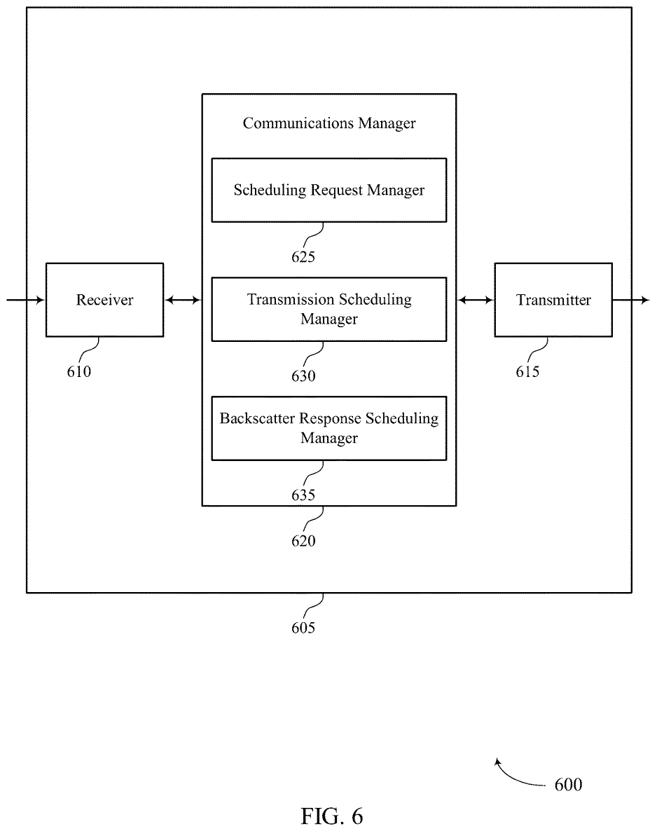

FIG. 6 shows a block diagram 600 of a device 605 that supports techniques for scheduling communication resources for backscatter modulation in accordance with one or more aspects of the present disclosure. The device 605 may be an example of aspects of a device 505 or a network entity 105 as described herein. The device 605 may include a receiver 610, a transmitter 615, and a communications manager 620. The device 605 may also include a processor. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some aspects, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some aspects, the transmitter 615 and the receiver 610 may be co-located in a transceiver, which may include or be coupled with a modem.

The device 605, or various components thereof, may be an example of means for performing various aspects of techniques for scheduling communication resources for backscatter modulation as described herein. For example, the communications manager 620 may include a scheduling request manager 625, a transmission scheduling manager 630, a backscatter response scheduling manager 635, or any combination thereof. The communications manager 620 may be an example of aspects of a communications manager 520 as described herein. In some aspects, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a first network node in accordance with examples as disclosed herein. The scheduling request manager 625 may be configured as or otherwise support a means for receiving, from one of a second network node or a third network node, a scheduling request, where the scheduling request is for a transmission from the second network node to an EH-capable device configured to perform backscattering. The transmission scheduling manager 630 may be configured as or otherwise support a means for transmitting, to the second network node, a first grant based on the scheduling request, where the first grant schedules a communication resource for the transmission. The backscatter response scheduling manager 635 may be configured as or otherwise support a means for transmitting, to the third network node, a second grant based on the scheduling request, where the second grant schedules the communication resource for reception of a backscatter response from the EH-capable device.

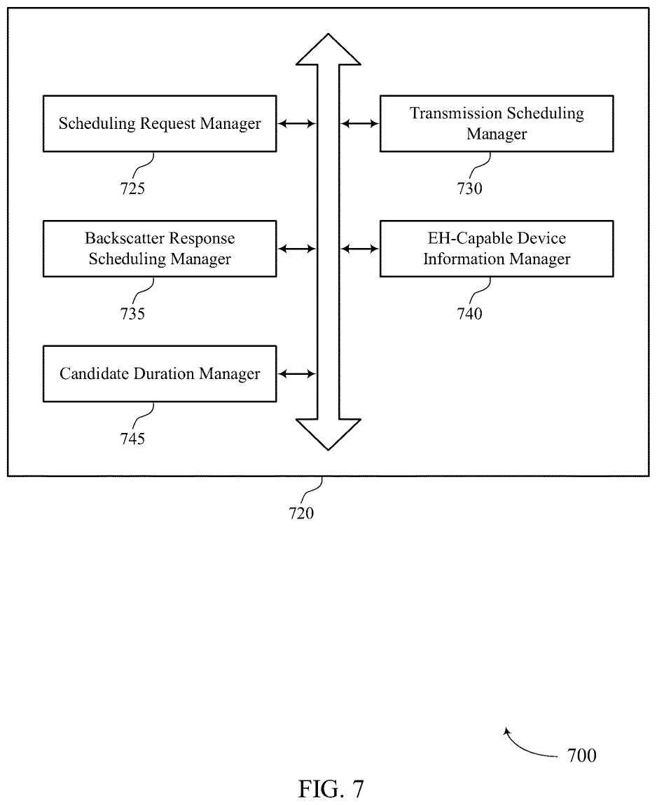

FIG. 7 shows a block diagram 700 of a communications manager 720 that supports techniques for scheduling communication resources for backscatter modulation in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for scheduling communication resources for backscatter modulation as described herein. For example, the communications manager 720 may include a scheduling request manager 725, a transmission scheduling manager 730, a backscatter response scheduling manager 735, a EH-capable device information manager 740, a candidate duration manager 745, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communications at a first network node in accordance with examples as disclosed herein. The scheduling request manager 725 may be configured as or otherwise support a means for receiving, from one of a second network node or a third network node, a scheduling request, where the scheduling request is for a transmission from the second network node to an EH-capable device configured to perform backscattering. The transmission scheduling manager 730 may be configured as or otherwise support a means for transmitting, to the second network node, a first grant based on the scheduling request, where the first grant schedules a communication resource for the transmission. The backscatter response scheduling manager 735 may be configured as or otherwise support a means for transmitting, to the third network node, a second grant based on the scheduling request, where the second grant schedules the communication resource for reception of a backscatter response from the EH-capable device.

In some aspects, the first grant is first DCI configured to activate a CG occasion for the second network node. In some aspects, the second grant is second DCI configured to activate the CG occasion for the third network node. In some aspects, the CG occasion is the communication resource.

In some aspects, each of the first DCI and the second DCI indicates a same quantity of slots as a duration of the CG occasion.

In some aspects, the candidate duration manager 745 may be configured as or otherwise support a means for transmitting, prior to transmission of the first grant and the second grant, an indication of one or more candidate durations of the CG occasion, where the same quantity of slots indicated in the first DCI and in the second DCI as the duration of the CG occasion is a designated one of the one or more candidate durations.

In some aspects, the first grant is indicative of a first quantity of slots for the transmission and the second grant is indicative of a second quantity of slots for the reception.

In some aspects, at least one of the first grant or the second grant is indicative of a division of the communication resource into a set of multiple slot types, the set of multiple slot types including at least one of a first slot type, a second slot type, or a third slot type. In some aspects, the first slot type is for provision of command information to the EH-capable device, the second slot type is for provision of a CW to elicit a back-scattering response from the EH-capable device, and the third slot type is for provision of a CW for energy-harvesting at the EH-capable device.

In some aspects, the at least one of the first grant or the second grant is indicative of at least one of a first quantity of the first slot type in the communication resource, a second quantity of the second slot type in the communication resource, or a third quantity of the third slot type in the communication resource.

In some aspects, the at least one of the first grant or the second grant is indicative of at least one of a first time offset between slots of the first slot type and the second slot type, a second time offset between slots of the second slot type and the third slot type, or a third time offset between slots of the first slot type and the third slot type.

In some aspects, at least one of the first time offset, the second time offset, or the third time offset is based on a capability of at least one of the second network node, the third network node, or the EH-capable device.

In some aspects, the first grant and the second grant are transmitted via a group common DCI that is transmitted to both the second network node and the third network node. In some aspects, the group common DCI indicates the second network node and the third network node from a set of multiple network nodes.

In some aspects, indication of the second network node and the third network node in the group common DCI is via a set of radio network temporary identifiers associated with the second network node and the third network node, a search space in which the group common DCI is transmitted, or one or more bits in a field of the group common DCI.

In some aspects, the EH-capable device information manager 740 may be configured as or otherwise support a means for transmitting to the second network node and the third network node, control information that is indicative of the EH-capable device, where the control information includes one or more of a type of the EH-capable device, an indication of the EH-capable device, a geographic zone of the EH-capable device, a sensor type included with the EH-capable device, a priority associated with the EH-capable device, or a QoS of data associated with the EH-capable device.

In some aspects, to support receiving the scheduling request, the scheduling request manager 725 may be configured as or otherwise support a means for receiving the scheduling request from the second network node.

In some aspects, to support receiving the scheduling request, the scheduling request manager 725 may be configured as or otherwise support a means for receiving the scheduling request from the third network node.

In some aspects, the scheduling request includes control information that is indicative of at least one of a type of the EH-capable device, a priority associated with the EH-capable device, a requested duration of the communication resource, latency information associated with backscattering at the EH-capable device, a geographic zone of the EH-capable device, a set of network nodes capable of receiving the backscattering, a set of network nodes capable of interrogating the EH-capable device, a processing capability of the second network node, and a processing capability of the third network node.

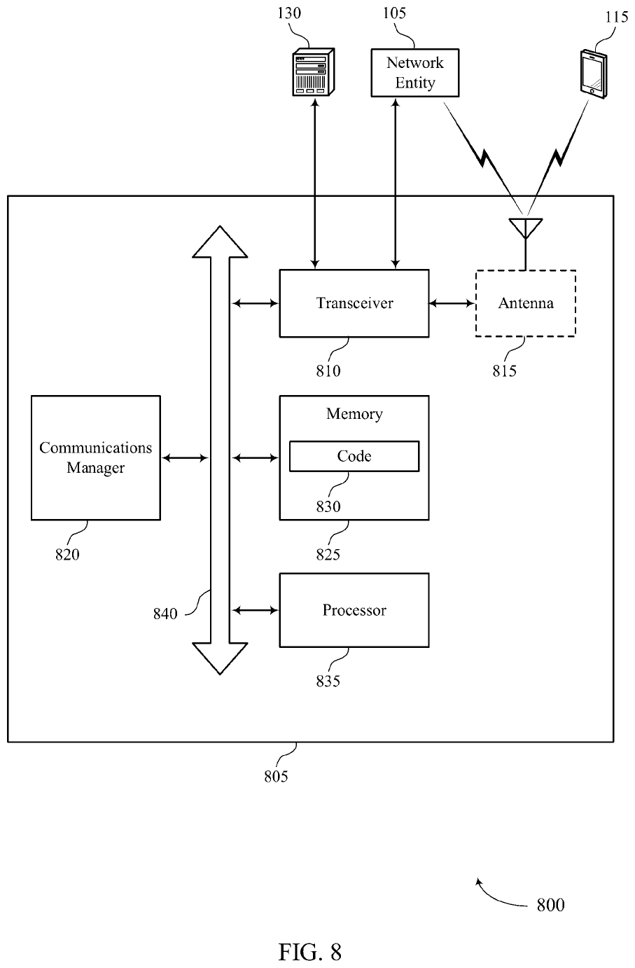

FIG. 8 shows a diagram of a system 800 including a device 805 that supports techniques for scheduling communication resources for backscatter modulation in accordance with one or more aspects of the present disclosure. The device 805 may be an example of or include the components of a device 505, a device 605, or a network entity 105 as described herein. The device 805 may communicate with one or more network entities 105, one or more UEs 115, or any combination thereof, which may include communications over one or more wired interfaces, over one or more wireless interfaces, or any combination thereof. The device 805 may include components that support outputting and obtaining communications, such as a communications manager 820, a transceiver 810, an antenna 815, a memory 825, code 830, and a processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some aspects, the transceiver 810 may include a wired transceiver and may communicate bi-directionally with another wired transceiver. Additionally, or alternatively, in some aspects, the transceiver 810 may include a wireless transceiver and may communicate bi-directionally with another wireless transceiver. In some aspects, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or memory components (for example, the processor 835, or the memory 825, or both), may be included in a chip or chip assembly that is installed in the device 805. In some aspects, the transceiver may be operable to support communications via one or more communications links (e.g., a communication link 125, a backhaul communication link 120, a midhaul communication link 162, a fronthaul communication link 168).

The memory 825 may include RAM and ROM. The memory 825 may store computer-readable, computer-executable code 830 including instructions that, when executed by the processor 835, cause the device 805 to perform various functions described herein. The code 830 may be stored in a non-transitory computer-readable medium such as system memory or another type of memory. In some cases, the code 830 may not be directly executable by the processor 835 but may cause a computer (e.g., when compiled and executed) to perform functions described herein. In some cases, the memory 825 may contain, among other things, a BIOS which may control basic hardware or software operation such as the interaction with peripheral components or devices.

The processor 835 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 835 may be configured to operate a memory array using a memory controller. In some other cases, a memory controller may be integrated into the processor 835. The processor 835 may be configured to execute computer-readable instructions stored in a memory (e.g., the memory 825) to cause the device 805 to perform various functions (e.g., functions or tasks supporting techniques for scheduling communication resources for backscatter modulation). For example, the device 805 or a component of the device 805 may include a processor 835 and memory 825 coupled with the processor 835, the processor 835 and memory 825 configured to perform various functions described herein. The processor 835 may be an example of a cloud-computing platform (e.g., one or more physical nodes and supporting software such as operating systems, virtual machines, or container instances) that may host the functions (e.g., by executing code 830) to perform the functions of the device 805. The processor 835 may be any one or more suitable processors capable of executing scripts or instructions of one or more software programs stored in the device 805 (such as within the memory 825). In some implementations, the processor 835 may be a component of a processing system. A processing system may generally refer to a system or series of machines or components that receives inputs and processes the inputs to produce a set of outputs (which may be passed to other systems or components of, for example, the device 805). For example, a processing system of the device 805 may refer to a system including the various other components or subcomponents of the device 805, such as the processor 835, or the transceiver 810, or the communications manager 820, or other components or combinations of components of the device 805. The processing system of the device 805 may interface with other components of the device 805, and may process information received from other components (such as inputs or signals) or output information to other components. For example, a chip or modem of the device 805 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 805 may transmit information output from the chip or modem. Additionally, or alternatively, in some implementations, the one or more interfaces may refer to an interface between the processing system of the chip or modem and a receiver, such that the device 805 may obtain information or signal inputs, and the information may be passed to the processing system. A person having ordinary skill in the art will readily recognize that a first interface also may obtain information or signal inputs, and a second interface also may output information or signal outputs.

In some aspects, a bus 840 may support communications of (e.g., within) a protocol layer of a protocol stack. In some aspects, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the memory 825, the code 830, and the processor 835 may be located in one of the different components or divided between different components).

In some aspects, the communications manager 820 may manage aspects of communications with a core network 130 (e.g., via one or more wired or wireless backhaul links). For example, the communications manager 820 may manage the transfer of data communications for client devices, such as one or more UEs 115. In some aspects, the communications manager 820 may manage communications with other network entities 105, and may include a controller or scheduler for controlling communications with UEs 115 in cooperation with other network entities 105. In some aspects, the communications manager 820 may support an X2 interface within an LTE/LTE-A wireless communications network technology to provide communication between network entities 105.

The communications manager 820 may support wireless communications at a first network node in accordance with examples as disclosed herein. For example, the communications manager 820 may be configured as or otherwise support a means for receiving, from one of a second network node or a third network node, a scheduling request, where the scheduling request is for a transmission from the second network node to an EH-capable device configured to perform backscattering. The communications manager 820 may be configured as or otherwise support a means for transmitting, to the second network node, a first grant based on the scheduling request, where the first grant schedules a communication resource for the transmission. The communications manager 820 may be configured as or otherwise support a means for transmitting, to the third network node, a second grant based on the scheduling request, where the second grant schedules the communication resource for reception of a backscatter response from the EH-capable device.

By including or configuring the communications manager 820 in accordance with examples as described herein, the device 805 may support techniques for more efficient utilization of communication resources and improved coordination between devices.

In some aspects, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some aspects, one or more functions described with reference to the communications manager 820 may be supported by or performed by the transceiver 810, the processor 835, the memory 825, the code 830, or any combination thereof. For example, the code 830 may include instructions executable by the processor 835 to cause the device 805 to perform various aspects of techniques for scheduling communication resources for backscatter modulation as described herein, or the processor 835 and the memory 825 may be otherwise configured to perform or support such operations.

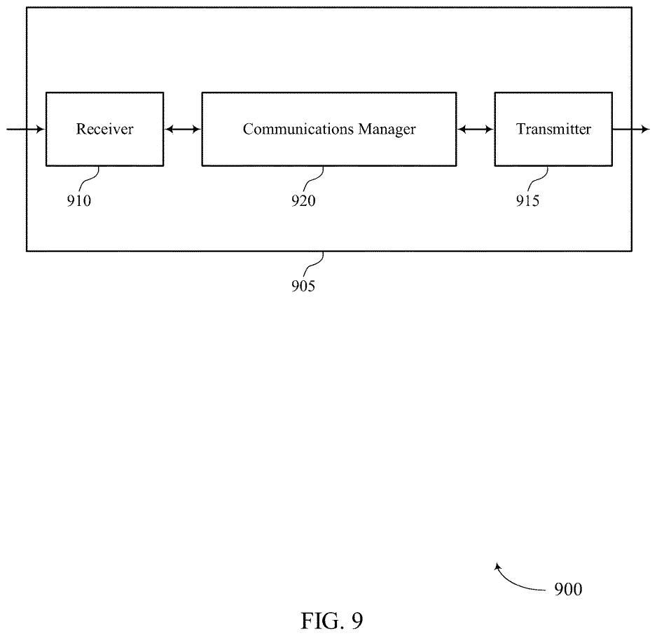

FIG. 9 shows a block diagram 900 of a device 905 that supports techniques for scheduling communication resources for backscatter modulation in accordance with one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for scheduling communication resources for backscatter modulation). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for scheduling communication resources for backscatter modulation). In some aspects, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of techniques for scheduling communication resources for backscatter modulation as described herein. For example, the communications manager 920, the receiver 910, the transmitter 915, or various combinations or components thereof may support a method for performing one or more of the functions described herein.

In some aspects, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some aspects, a processor and memory coupled with the processor may be configured to perform one or more of the functions described herein (e.g., by executing, by the processor, instructions stored in the memory).

Additionally, or alternatively, in some aspects, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some aspects, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a first network node in accordance with examples as disclosed herein. For example, the communications manager 920 may be configured as or otherwise support a means for receiving, from a second network node, a grant that schedules a communication resource for reception of a backscatter response from an EH-capable device, where the backscatter response is responsive to a transmission from a third network node to the EH-capable device. The communications manager 920 may be configured as or otherwise support a means for receiving the backscatter response via the communication resource in accordance with the grant.

Additionally, or alternatively, the communications manager 920 may support wireless communications at a first network node in accordance with examples as disclosed herein. For example, the communications manager 920 may be configured as or otherwise support a means for receiving, from a second network node, a grant that schedules a communication resource for a transmission, where the transmission is from the first network node to an EH-capable device configured to perform backscattering. The communications manager 920 may be configured as or otherwise support a means for communicating, to the EH-capable device, the transmission via the communication resource in accordance with the grant.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for more efficient utilization of communication resources.

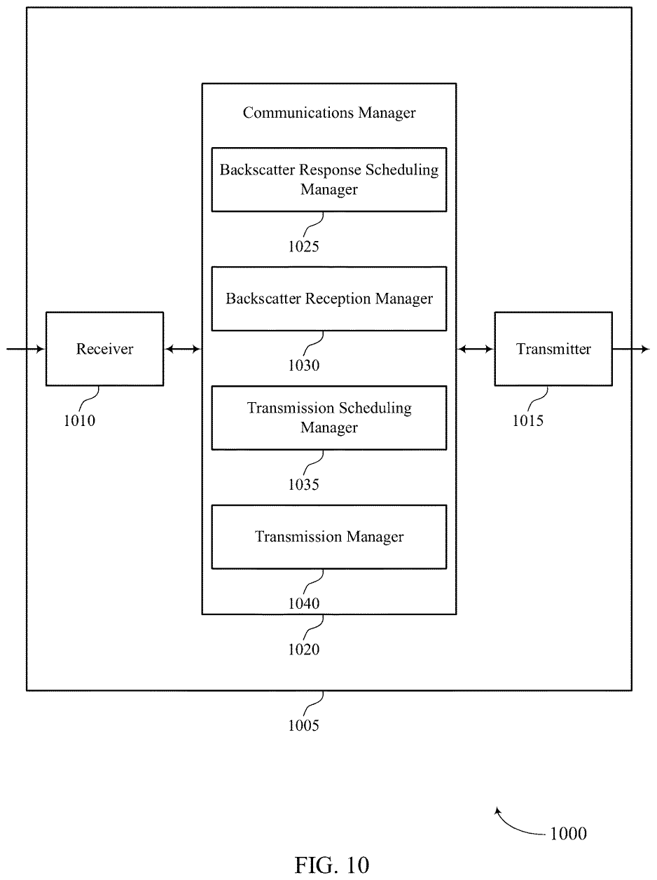

FIG. 10 shows a block diagram 1000 of a device 1005 that supports techniques for scheduling communication resources for backscatter modulation in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to techniques for scheduling communication resources for backscatter modulation). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for scheduling communication resources for backscatter modulation). In some aspects, the transmitter 1015 may be co-located with a receiver 1010 in a transceiver module. The transmitter 1015 may utilize a single antenna or a set of multiple antennas.

The device 1005, or various components thereof, may be an example of means for performing various aspects of techniques for scheduling communication resources for backscatter modulation as described herein. For example, the communications manager 1020 may include a backscatter response scheduling manager 1025, a backscatter reception manager 1030, a transmission scheduling manager 1035, a transmission manager 1040, or any combination thereof. The communications manager 1020 may be an example of aspects of a communications manager 920 as described herein. In some aspects, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a first network node in accordance with examples as disclosed herein. The backscatter response scheduling manager 1025 may be configured as or otherwise support a means for receiving, from a second network node, a grant that schedules a communication resource for reception of a backscatter response from an EH-capable device, where the backscatter response is responsive to a transmission from a third network node to the EH-capable device. The backscatter reception manager 1030 may be configured as or otherwise support a means for receiving the backscatter response via the communication resource in accordance with the grant.

Additionally, or alternatively, the communications manager 1020 may support wireless communications at a first network node in accordance with examples as disclosed herein. The transmission scheduling manager 1035 may be configured as or otherwise support a means for receiving, from a second network node, a grant that schedules a communication resource for a transmission, where the transmission is from the first network node to an EH-capable device configured to perform backscattering. The transmission manager 1040 may be configured as or otherwise support a means for communicating, to the EH-capable device, the transmission via the communication resource in accordance with the grant.

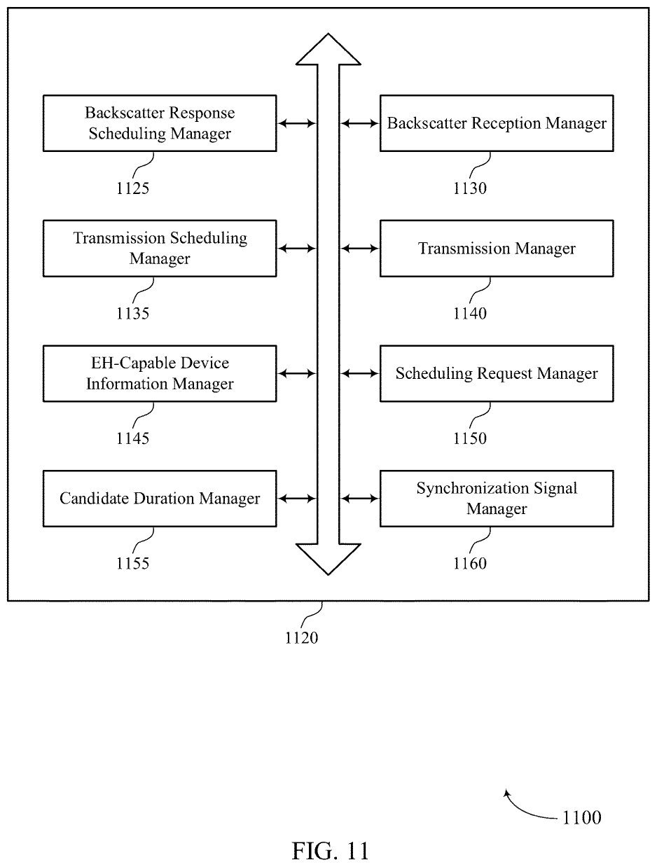

FIG. 11 shows a block diagram 1100 of a communications manager 1120 that supports techniques for scheduling communication resources for backscatter modulation in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for scheduling communication resources for backscatter modulation as described herein. For example, the communications manager 1120 may include a backscatter response scheduling manager 1125, a backscatter reception manager 1130, a transmission scheduling manager 1135, a transmission manager 1140, a EH-capable device information manager 1145, a scheduling request manager 1150, a candidate duration manager 1155, a synchronization signal manager 1160, or any combination thereof. Each of these components may communicate, directly or indirectly, with one another (e.g., via one or more buses).

The communications manager 1120 may support wireless communications at a first network node in accordance with examples as disclosed herein. The backscatter response scheduling manager 1125 may be configured as or otherwise support a means for receiving, from a second network node, a grant that schedules a communication resource for reception of a backscatter response from an EH-capable device, where the backscatter response is responsive to a transmission from a third network node to the EH-capable device. The backscatter reception manager 1130 may be configured as or otherwise support a means for receiving the backscatter response via the communication resource in accordance with the grant.

In some aspects, the grant is DCI configured to activate a CG occasion for the first network node. In some aspects, the CG occasion is the communication resource.

In some aspects, the DCI indicates a quantity of slots as a duration for the CG occasion.

In some aspects, the candidate duration manager 1155 may be configured as or otherwise support a means for receiving, prior to reception of the grant, an indication of one or more candidate durations of the CG occasion, where the quantity of slots indicated in the DCI as the duration of the CG occasion is a designated one of the one or more candidate durations.

In some aspects, the grant is indicative of a quantity of slots for the reception.

In some aspects, the grant is indicative of a division of the communication resource into a set of multiple slot types, the set of multiple slot types including at least one of a first slot type, a second slot type, or a third slot type. In some aspects, the first slot type is for provision of command information to the EH-capable device, the second slot type is for provision of a CW to elicit a back-scattering response from the EH-capable device, and the third slot type is for provision of a CW for energy-harvesting at the EH-capable device.

In some aspects, the grant is indicative of at least one of a first quantity of the first slot type in the communication resource, a second quantity of the second slot type in the communication resource, or a third quantity of the third slot type in the communication resource.

In some aspects, the grant is indicative of at least one of a first time offset between slots of the first slot type and the second slot type, a second time offset between slots of the second slot type and the third slot type, or a third time offset between slots of the first slot type and the third slot type.

In some aspects, at least one of the first time offset, the second time offset, or the third time offset is based on a capability of at least one of the third network node, the first network node, or the EH-capable device.

In some aspects, the synchronization signal manager 1160 may be configured as or otherwise support a means for receiving, during a slot of the second slot type, a synchronization signal indicative of a periodicity of the transmission.

In some aspects, the grant is received via a group common DCI. In some aspects, the group common DCI indicates the first network node from a set of multiple network nodes.

In some aspects, indication of the first network node in the group common DCI is via a set of radio network temporary identifiers associated with the first network node, a search space in which the group common DCI is transmitted, or one or more bits in a field of the group common DCI.

In some aspects, the EH-capable device information manager 1145 may be configured as or otherwise support a means for receiving, from the second network node, control information that is indicative of the EH-capable device, where the control information includes one or more of a type of the EH-capable device, an indication of the EH-capable device, a geographic zone of the EH-capable device, a sensor type included with the EH-capable device, a priority associated with the EH-capable device, or a QoS of data associated with the EH-capable device.

In some aspects, the scheduling request manager 1150 may be configured as or otherwise support a means for transmitting, to the second network node, a scheduling request for the transmission, where the grant is responsive to the scheduling request.

In some aspects, the scheduling request includes control information that is indicative of at least one of a type of the EH-capable device, a priority associated with the EH-capable device, a requested duration of the communication resource, latency information associated with backscattering at the EH-capable device, a geographic zone of the EH-capable device, a set of network nodes capable of interrogating the EH-capable device, and a processing capability of the first network node.

Additionally, or alternatively, the communications manager 1120 may support wireless communications at a first network node in accordance with examples as disclosed herein. The transmission scheduling manager 1135 may be configured as or otherwise support a means for receiving, from a second network node, a grant that schedules a communication resource for a transmission, where the transmission is from the first network node to an EH-capable device configured to perform backscattering. The transmission manager 1140 may be configured as or otherwise support a means for communicating, to the EH-capable device, the transmission via the communication resource in accordance with the grant.

In some aspects, the grant is DCI configured to activate a CG occasion for the first network node. In some aspects, the CG occasion is the communication resource.

In some aspects, the DCI indicates a quantity of slots as a duration for the CG occasion.

In some aspects, the candidate duration manager 1155 may be configured as or otherwise support a means for receiving, prior to reception of the grant, an indication of one or more candidate durations of the CG occasion, where the quantity of slots indicated in the DCI as the duration of the CG occasion is a designated one of the one or more candidate durations.

In some aspects, the grant is indicative of a quantity of slots for the transmission.

In some aspects, the grant is indicative of a division of the communication resource into a set of multiple slot types, the set of multiple slot types including at least one of a first slot type, a second slot type, or a third slot type. In some aspects, the first slot type is for provision of command information to the EH-capable device, the second slot type is for provision of a CW to elicit a back-scattering response from the EH-capable device, and the third slot type is for provision of a CW for energy-harvesting at the EH-capable device.

In some aspects, the grant is indicative of at least one of a first quantity of the first slot type in the communication resource, a second quantity of the second slot type in the communication resource, or a third quantity of the third slot type in the communication resource.

In some aspects, the grant is indicative of at least one of a first time offset between slots of the first slot type and the second slot type, a second time offset between slots of the second slot type and the third slot type, or a third time offset between slots of the first slot type and the third slot type.

In some aspects, at least one of the first time offset, the second time offset, or the third time offset is based on a capability of at least one of the first network node, a third network node, or the EH-capable device.

In some aspects, the synchronization signal manager 1160 may be configured as or otherwise support a means for transmitting, during a slot of the second slot type, a synchronization signal indicative of a periodicity of the transmission.

In some aspects, the grant is received via a group common DCI. In some aspects, the group common DCI indicates the first network node from a set of multiple network nodes.

In some aspects, indication of the first network node in the group common DCI is via a set of radio network temporary identifiers associated with the first network node, a search space in which the group common DCI is transmitted, or one or more bits in a field of the group common DCI.

In some aspects, the EH-capable device information manager 1145 may be configured as or otherwise support a means for receiving, from the second network node, control information that is indicative of the EH-capable device, where the control information includes one or more of a type of the EH-capable device, an indication of the EH-capable device, a geographic zone of the EH-capable device, a sensor type included with the EH-capable device, a priority associated with the EH-capable device, or a QoS of data associated with the EH-capable device.

In some aspects, the scheduling request manager 1150 may be configured as or otherwise support a means for transmitting, to the second network node, a scheduling request for the transmission, where the grant is responsive to the scheduling request.

In some aspects, the scheduling request includes control information that is indicative of at least one of a type of the EH-capable device, a priority associated with the EH-capable device, a requested duration of the communication resource, latency information associated with backscattering at the EH-capable device, a geographic zone of the EH-capable device, set of network nodes capable of receiving the backscattering, and a processing capability of the first network node.

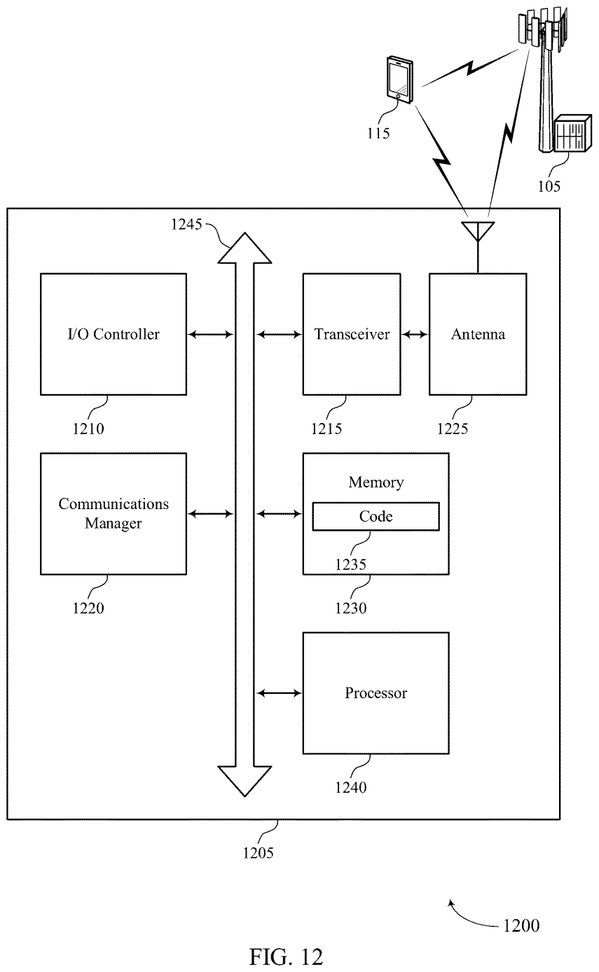

FIG. 12 shows a diagram of a system 1200 including a device 1205 that supports techniques for scheduling communication resources for backscatter modulation in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting techniques for scheduling communication resources for backscatter modulation). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communications at a first network node in accordance with examples as disclosed herein. For example, the communications manager 1220 may be configured as or otherwise support a means for receiving, from a second network node, a grant that schedules a communication resource for reception of a backscatter response from an EH-capable device, where the backscatter response is responsive to a transmission from a third network node to the EH-capable device. The communications manager 1220 may be configured as or otherwise support a means for receiving the backscatter response via the communication resource in accordance with the grant.

Additionally, or alternatively, the communications manager 1220 may support wireless communications at a first network node in accordance with examples as disclosed herein. For example, the communications manager 1220 may be configured as or otherwise support a means for receiving, from a second network node, a grant that schedules a communication resource for a transmission, where the transmission is from the first network node to an EH-capable device configured to perform backscattering. The communications manager 1220 may be configured as or otherwise support a means for communicating, to the EH-capable device, the transmission via the communication resource in accordance with the grant.

By including or configuring the communications manager 1220 in accordance with examples as described herein, the device 1205 may support techniques for more efficient utilization of communication resources and improved coordination between devices.

In some aspects, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some aspects, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of techniques for scheduling communication resources for backscatter modulation as described herein, or the processor 1240 and the memory 1230 may be otherwise configured to perform or support such operations.

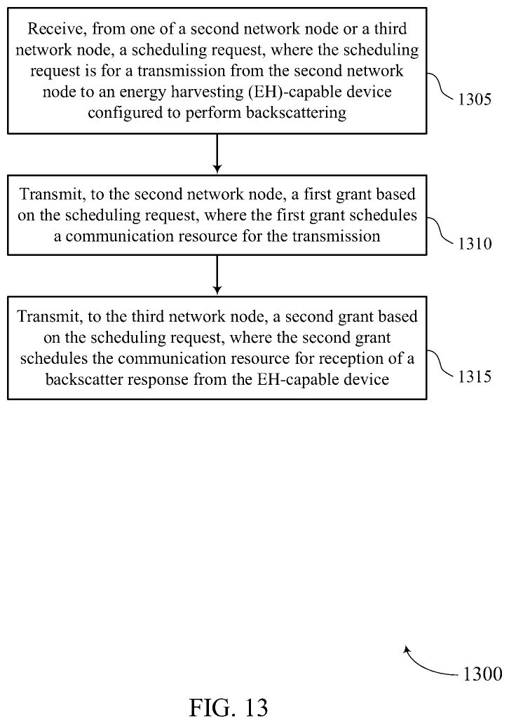

FIG. 13 shows a flowchart illustrating a method 1300 that supports techniques for scheduling communication resources for backscatter modulation in accordance with one or more aspects of the present disclosure. The operations of the method 1300 may be implemented by a network entity or its components as described herein. For example, the operations of the method 1300 may be performed by a network entity as described with reference to FIGS. 1 through 8. In some aspects, a network entity may execute a set of instructions to control the functional elements of the network entity to perform the described functions. Additionally, or alternatively, the network entity may perform aspects of the described functions using special-purpose hardware.

At 1305, the method may include receiving, from one of a second network node or a third network node, a scheduling request, where the scheduling request is for a transmission from the second network node to an EH-capable device configured to perform backscattering. The operations of 1305 may be performed in accordance with examples as disclosed herein. In some aspects, aspects of the operations of 1305 may be performed by a scheduling request manager 725 as described with reference to FIG. 7.

At 1310, the method may include transmitting, to the second network node, a first grant based on the scheduling request, where the first grant schedules a communication resource for the transmission. The operations of 1310 may be performed in accordance with examples as disclosed herein. In some aspects, aspects of the operations of 1310 may be performed by a transmission scheduling manager 730 as described with reference to FIG. 7.

At 1315, the method may include transmitting, to the third network node, a second grant based on the scheduling request, where the second grant schedules the communication resource for reception of a backscatter response from the EH-capable device. The operations of 1315 may be performed in accordance with examples as disclosed herein. In some aspects, aspects of the operations of 1315 may be performed by a backscatter response scheduling manager 735 as described with reference to FIG. 7.

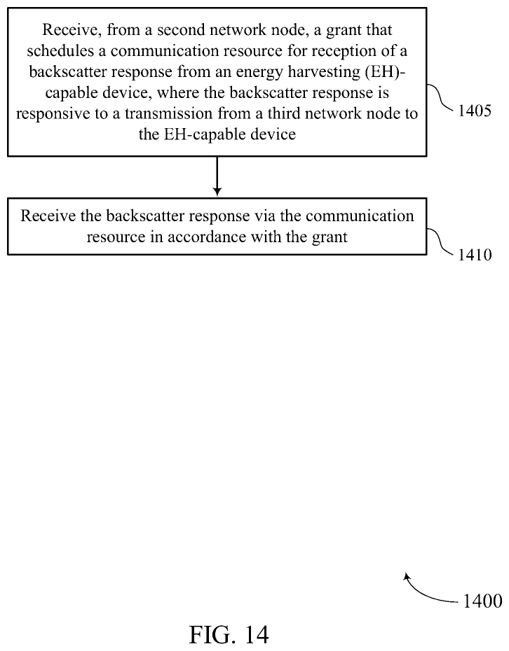

FIG. 14 shows a flowchart illustrating a method 1400 that supports techniques for scheduling communication resources for backscatter modulation in accordance with one or more aspects of the present disclosure. The operations of the method 1400 may be implemented by a UE or its components as described herein. For example, the operations of the method 1400 may be performed by a UE 115 as described with reference to FIGS. 1 through 4 and 9 through 12. In some aspects, a UE may execute a set of instructions to control the functional elements of the UE to perform the described functions. Additionally, or alternatively, the UE may perform aspects of the described functions using special-purpose hardware.

At 1405, the method may include receiving, from a second network node, a grant that schedules a communication resource for reception of a backscatter response from an EH-capable device, where the backscatter response is responsive to a transmission from a third network node to the EH-capable device. The operations of 1405 may be performed in accordance with examples as disclosed herein. In some aspects, aspects of the operations of 1405 may be performed by a backscatter response scheduling manager 1125 as described with reference to FIG. 11.

At 1410, the method may include receiving the backscatter response via the communication resource in accordance with the grant. The operations of 1410 may be performed in accordance with examples as disclosed herein. In some aspects, aspects of the operations of 1410 may be performed by a backscatter reception manager 1130 as described with reference to FIG. 11.

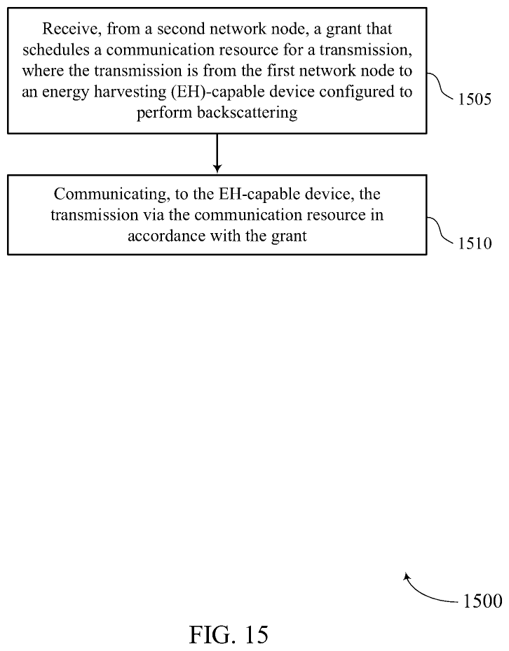

FIG. 15 shows a flowchart illustrating a method 1500 that supports techniques for scheduling communication resources for backscatter modulation in accordance with one or more aspects of the present disclosure. The operations of the method 1500 may be implemented by a UE or its components as described herein. For example, the operations of the method 1500 may be performed by a UE 115 as described with reference to FIGS. 1 through 4 and 9 through 12. In some aspects, a UE may execute a set of instructions to control the functional elements of the UE to perform the described functions. Additionally, or alternatively, the UE may perform aspects of the described functions using special-purpose hardware.

At 1505, the method may include receiving, from a second network node, a grant that schedules a communication resource for a transmission, where the transmission is from the first network node to an EH-capable device configured to perform backscattering. The operations of 1505 may be performed in accordance with examples as disclosed herein. In some aspects, aspects of the operations of 1505 may be performed by a transmission scheduling manager 1135 as described with reference to FIG. 11.

At 1510, the method may include communicating, to the EH-capable device, the transmission via the communication resource in accordance with the grant. The operations of 1510 may be performed in accordance with examples as disclosed herein. In some aspects, aspects of the operations of 1510 may be performed by a transmission manager 1140 as described with reference to FIG. 11.

The following provides an overview of aspects of the present disclosure:
Aspect 1: A method for wireless communications at a first network node, comprising: receiving, from one of a second network node or a third network node, a scheduling request, wherein the scheduling request is for a transmission from the second network node to an EH-capable device configured to perform backscattering; transmitting, to the second network node, a first grant based on the scheduling request, wherein the first grant schedules a communication resource for the transmission; and transmitting, to the third network node, a second grant based on the scheduling request, wherein the second grant schedules the communication resource for reception of a backscatter response from the EH-capable device.
Aspect 2: The method of aspect 1, wherein the first grant is first DCI configured to activate a CG occasion for the second network node, and the second grant is second DCI configured to activate the CG occasion for the third network node, the CG occasion is the communication resource.
Aspect 3: The method of aspect 2, wherein each of the first DCI and the second DCI indicates a same quantity of slots as a duration of the CG occasion.
Aspect 4: The method of aspect 3, further comprising: transmitting, prior to transmission of the first grant and the second grant, an indication of one or more candidate durations of the CG occasion, wherein the same quantity of slots indicated in the first DCI and in the second DCI as the duration of the CG occasion is a designated one of the one or more candidate durations.
Aspect 5: The method of any of aspects 1 through 4, wherein the first grant is indicative of a first quantity of slots for the transmission and the second grant is indicative of a second quantity of slots for the reception.
Aspect 6: The method of any of aspects 1 through 5, wherein at least one of the first grant or the second grant is indicative of a division of the communication resource into a plurality of slot types, the plurality of slot types including at least one of a first slot type, a second slot type, or a third slot type, and the first slot type is for provision of command information to the EH-capable device, the second slot type is for provision of a continuous wave to elicit a back-scattering response from the EH-capable device, and the third slot type is for provision of a continuous wave for energy-harvesting at the EH-capable device.
Aspect 7: The method of aspect 6, wherein the at least one of the first grant or the second grant is indicative of at least one of a first quantity of the first slot type in the communication resource, a second quantity of the second slot type in the communication resource, or a third quantity of the third slot type in the communication resource.
Aspect 8: The method of any of aspects 6 through 7, wherein the at least one of the first grant or the second grant is indicative of at least one of a first time offset between slots of the first slot type and the second slot type, a second time offset between slots of the second slot type and the third slot type, or a third time offset between slots of the first slot type and the third slot type.
Aspect 9: The method of aspect 8, wherein at least one of the first time offset, the second time offset, or the third time offset is based on a capability of at least one of the second network node, the third network node, or the EH-capable device.
Aspect 10: The method of any of aspects 1 through 9, wherein the first grant and the second grant are transmitted via a group common DCI that is transmitted to both the second network node and the third network node, and the group common DCI indicates the second network node and the third network node from a plurality of network nodes.
Aspect 11: The method of aspect 10, wherein indication of the second network node and the third network node in the group common DCI is via a set of radio network temporary identifiers associated with the second network node and the third network node, a search space in which the group common DCI is transmitted, or one or more bits in a field of the group common DCI.
Aspect 12: The method of any of aspects 1 through 11, further comprising: transmitting to the second network node and the third network node, control information that is indicative of the EH-capable device, wherein the control information includes one or more of a type of the EH-capable device, an indication of the EH-capable device, a geographic zone of the EH-capable device, a sensor type included with the EH-capable device, a priority associated with the EH-capable device, or a quality-of-service of data associated with the EH-capable device.
Aspect 13: The method of any of aspects 1 through 12, wherein receiving the scheduling request comprises: receiving the scheduling request from the second network node.
Aspect 14: The method of any of aspects 1 through 12, wherein receiving the scheduling request comprises: receiving the scheduling request from the third network node.
Aspect 15: The method of any of aspects 1 through 14, wherein the scheduling request comprises control information that is indicative of at least one of a type of the EH-capable device, a priority associated with the EH-capable device, a requested duration of the communication resource, latency information associated with backscattering at the EH-capable device, a geographic zone of the EH-capable device, a set of network nodes capable of receiving the backscattering, a set of network nodes capable of interrogating the EH-capable device, a processing capability of the second network node, and a processing capability of the third network node.
Aspect 16: A method for wireless communications at a first network node, comprising: receiving, from a second network node, a grant that schedules a communication resource for reception of a backscatter response from an EH-capable device, wherein the backscatter response is responsive to a transmission from a third network node to the EH-capable device; and receiving the backscatter response via the communication resource in accordance with the grant.
Aspect 17: The method of aspect 16, wherein the grant is DCI configured to activate a CG occasion for the first network node, the CG occasion is the communication resource.
Aspect 18: The method of aspect 17, wherein the DCI indicates a quantity of slots as a duration for the CG occasion.
Aspect 19: The method of aspect 18, further comprising: receiving, prior to reception of the grant, an indication of one or more candidate durations of the CG occasion, wherein the quantity of slots indicated in the DCI as the duration of the CG occasion is a designated one of the one or more candidate durations.
Aspect 20: The method of any of aspects 16 through 19, wherein the grant is indicative of a quantity of slots for the reception.
Aspect 21: The method of any of aspects 16 through 20, wherein the grant is indicative of a division of the communication resource into a plurality of slot types, the plurality of slot types including at least one of a first slot type, a second slot type, or a third slot type, and the first slot type is for provision of command information to the EH-capable device, the second slot type is for provision of a continuous wave to elicit a back-scattering response from the EH-capable device, and the third slot type is for provision of a continuous wave for energy-harvesting at the EH-capable device.
Aspect 22: The method of aspect 21, wherein the grant is indicative of at least one of a first quantity of the first slot type in the communication resource, a second quantity of the second slot type in the communication resource, or a third quantity of the third slot type in the communication resource.
Aspect 23: The method of any of aspects 21 through 22, wherein the grant is indicative of at least one of a first time offset between slots of the first slot type and the second slot type, a second time offset between slots of the second slot type and the third slot type, or a third time offset between slots of the first slot type and the third slot type.
Aspect 24: The method of aspect 23, wherein at least one of the first time offset, the second time offset, or the third time offset is based on a capability of at least one of the third network node, the first network node, or the EH-capable device.
Aspect 25: The method of any of aspects 23 through 24, further comprising: receiving, during a slot of the second slot type, a synchronization signal indicative of a periodicity of the transmission.
Aspect 26: The method of any of aspects 16 through 25, wherein the grant is received via a group common DCI, and the group common DCI indicates the first network node from a plurality of network nodes.
Aspect 27: The method of aspect 26, wherein indication of the first network node in the group common DCI is via a set of radio network temporary identifiers associated with the first network node, a search space in which the group common DCI is transmitted, or one or more bits in a field of the group common DCI.
Aspect 28: The method of any of aspects 16 through 27, further comprising: receiving, from the second network node, control information that is indicative of the EH-capable device, wherein the control information includes one or more of a type of the EH-capable device, an indication of the EH-capable device, a geographic zone of the EH-capable device, a sensor type included with the EH-capable device, a priority associated with the EH-capable device, or a quality-of-service of data associated with the EH-capable device.
Aspect 29: The method of any of aspects 16 through 28, further comprising: transmitting, to the second network node, a scheduling request for the transmission, wherein the grant is responsive to the scheduling request.
Aspect 30: The method of aspect 29, wherein the scheduling request comprises control information that is indicative of at least one of a type of the EH-capable device, a priority associated with the EH-capable device, a requested duration of the communication resource, latency information associated with backscattering at the EH-capable device, a geographic zone of the EH-capable device, a set of network nodes capable of interrogating the EH-capable device, and a processing capability of the first network node.
Aspect 31: A method for wireless communications at a first network node, comprising: receiving, from a second network node, a grant that schedules a communication resource for a transmission, wherein the transmission is from the first network node to an EH-capable device configured to perform backscattering; and communicating, to the EH-capable device, the transmission via the communication resource in accordance with the grant.
Aspect 32: The method of aspect 31, wherein the grant is DCI configured to activate a CG occasion for the first network node, the CG occasion is the communication resource.
Aspect 33: The method of aspect 32, wherein the DCI indicates a quantity of slots as a duration for the CG occasion.
Aspect 34: The method of aspect 33, further comprising: receiving, prior to reception of the grant, an indication of one or more candidate durations of the CG occasion, wherein the quantity of slots indicated in the DCI as the duration of the CG occasion is a designated one of the one or more candidate durations.
Aspect 35: The method of any of aspects 31 through 34, wherein the grant is indicative of a quantity of slots for the transmission.
Aspect 36: The method of any of aspects 31 through 35, wherein the grant is indicative of a division of the communication resource into a plurality of slot types, the plurality of slot types including at least one of a first slot type, a second slot type, or a third slot type, and the first slot type is for provision of command information to the EH-capable device, the second slot type is for provision of a continuous wave to elicit a back-scattering response from the EH-capable device, and the third slot type is for provision of a continuous wave for energy-harvesting at the EH-capable device.
Aspect 37: The method of aspect 36, wherein the grant is indicative of at least one of a first quantity of the first slot type in the communication resource, a second quantity of the second slot type in the communication resource, or a third quantity of the third slot type in the communication resource.
Aspect 38: The method of any of aspects 36 through 37, wherein the grant is indicative of at least one of a first time offset between slots of the first slot type and the second slot type, a second time offset between slots of the second slot type and the third slot type, or a third time offset between slots of the first slot type and the third slot type.
Aspect 39: The method of aspect 38, wherein at least one of the first time offset, the second time offset, or the third time offset is based on a capability of at least one of the first network node, a third network node, or the EH-capable device.
Aspect 40: The method of any of aspects 38 through 39, further comprising: transmitting, during a slot of the second slot type, a synchronization signal indicative of a periodicity of the transmission.
Aspect 41: The method of any of aspects 31 through 40, wherein the grant is received via a group common DCI, and the group common DCI indicates the first network node from a plurality of network nodes.
Aspect 42: The method of aspect 41, wherein indication of the first network node in the group common DCI is via a set of radio network temporary identifiers associated with the first network node, a search space in which the group common DCI is transmitted, or one or more bits in a field of the group common DCI.
Aspect 43: The method of any of aspects 31 through 42, further comprising: receiving, from the second network node, control information that is indicative of the EH-capable device, wherein the control information includes one or more of a type of the EH-capable device, an indication of the EH-capable device, a geographic zone of the EH-capable device, a sensor type included with the EH-capable device, a priority associated with the EH-capable device, or a quality-of-service of data associated with the EH-capable device.
Aspect 44: The method of any of aspects 31 through 43, further comprising: transmitting, to the second network node, a scheduling request for the transmission, wherein the grant is responsive to the scheduling request.
Aspect 45: The method of aspect 44, wherein the scheduling request comprises control information that is indicative of at least one of a type of the EH-capable device, a priority associated with the EH-capable device, a requested duration of the communication resource, latency information associated with backscattering at the EH-capable device, a geographic zone of the EH-capable device, set of network nodes capable of receiving the backscattering, and a processing capability of the first network node.
Aspect 46: A first network node for wireless communications, comprising a memory; and at least one processor coupled to the memory, wherein the at least one processor is configured to perform a method of any of aspects 1 through 15.
Aspect 47: An apparatus for wireless communications at a first network node, comprising at least one means for performing a method of any of aspects 1 through 15.
Aspect 48: A non-transitory computer-readable medium having code for wireless communication stored thereon that, when executed by a first network node, causes the first network node to perform a method of any of aspects 1 through 15.
Aspect 49: A first network node for wireless communications, comprising a memory; and at least one processor coupled to the memory, wherein the at least one processor is configured to perform a method of any of aspects 16 through 30.
Aspect 50: An apparatus for wireless communications at a first network node, comprising at least one means for performing a method of any of aspects 16 through 30.
Aspect 51: A non-transitory computer-readable medium having code for wireless communication stored thereon that, when executed by a first network node, causes the first network node to perform a method of any of aspects 16 through 30.
Aspect 52: A first network node for wireless communications, comprising a memory; and at least one processor coupled to the memory, wherein the at least one processor is configured to perform a method of any of aspects 31 through 45.
Aspect 53: An apparatus for wireless communications at a first network node, comprising at least one means for performing a method of any of aspects 31 through 45.
Aspect 54: A non-transitory computer-readable medium having code for wireless communication stored thereon that, when executed by a first network node, causes the first network node to perform a method of any of aspects 31 through 45.

The methods described herein describe possible implementations, and the operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers.

Combinations of the above are also included within the scope of computer-readable media.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration,” and not “preferred” or “advantageous over other aspects.” The detailed description includes specific details for the purpose of providing an understanding of the described techniques. These techniques, however, may be practiced without these specific details. In some instances, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A first network node for wireless communications, comprising:
a memory; and
at least one processor coupled to the memory, wherein the at least one processor is configured to:
receive, from one of a second network node or a third network node, a scheduling request, wherein the scheduling request is for a transmission from the second network node to an energy harvesting (EH)-capable device configured to perform backscattering;
transmit, to the second network node, a first grant based on the scheduling request, wherein the first grant schedules a communication resource for the transmission; and
transmit, to the third network node, a second grant based on the scheduling request, wherein the second grant schedules the communication resource for reception of a backscatter response from the EH-capable device.

2. The first network node of claim 1, wherein the first grant is first downlink control information configured to activate a configured grant occasion for the second network node, and wherein the second grant is second downlink control information configured to activate the configured grant occasion for the third network node, wherein the configured grant occasion is the communication resource.

3. The first network node of claim 2, wherein each of the first downlink control information and the second downlink control information indicates a same quantity of slots as a duration of the configured grant occasion.

4. The first network node of claim 3, wherein the at least one processor is further configured to:
transmit, prior to transmission of the first grant and the second grant, an indication of one or more candidate durations of the configured grant occasion, wherein the same quantity of slots indicated in the first downlink control information and in the second downlink control information as the duration of the configured grant occasion is a designated one of the one or more candidate durations.

5. The first network node of claim 1, wherein the first grant is indicative of a first quantity of slots for the transmission and the second grant is indicative of a second quantity of slots for the reception.

6. The first network node of claim 1, wherein at least one of the first grant or the second grant is indicative of a division of the communication resource into a plurality of slot types, the plurality of slot types including at least one of a first slot type, a second slot type, or a third slot type, and wherein the first slot type is for provision of command information to the EH-capable device, the second slot type is for provision of a continuous wave to elicit a back-scattering response from the EH-capable device, and the third slot type is for provision of a continuous wave for energy-harvesting at the EH-capable device.

7. The first network node of claim 6, wherein the at least one of the first grant or the second grant is indicative of at least one of a first quantity of the first slot type in the communication resource, a second quantity of the second slot type in the communication resource, or a third quantity of the third slot type in the communication resource.

8. The first network node of claim 6, wherein the at least one of the first grant or the second grant is indicative of at least one of a first time offset between slots of the first slot type and the second slot type, a second time offset between slots of the second slot type and the third slot type, or a third time offset between slots of the first slot type and the third slot type.

9. The first network node of claim 8, wherein at least one of the first time offset, the second time offset, or the third time offset is based on a capability of at least one of the second network node, the third network node, or the EH-capable device.

10. The first network node of claim 1, wherein the first grant and the second grant are transmitted via a group common downlink control information that is transmitted to both the second network node and the third network node, and wherein the group common downlink control information indicates the second network node and the third network node from a plurality of network nodes.

11. The first network node of claim 10, wherein indication of the second network node and the third network node in the group common downlink control information is via a set of radio network temporary identifiers associated with the second network node and the third network node, a search space in which the group common downlink control information is transmitted, or one or more bits in a field of the group common downlink control information.

12. The first network node of claim 1, wherein the at least one processor is further configured to:
transmit to the second network node and the third network node, control information that is indicative of the EH-capable device, wherein the control information includes one or more of a type of the EH-capable device, an indication of the EH-capable device, a geographic zone of the EH-capable device, a sensor type included with the EH-capable device, a priority associated with the EH-capable device, or a quality-of-service of data associated with the EH-capable device.

13. The first network node of claim 1, wherein to receive the scheduling request, the at least one processor is configured to:
receive the scheduling request from the second network node.

14. The first network node of claim 1, wherein to receive the scheduling request, the at least one processor is configured to:
receive the scheduling request from the third network node.

15. The first network node of claim 1, wherein the scheduling request comprises control information that is indicative of at least one of a type of the EH-capable device, a priority associated with the EH-capable device, a requested duration of the communication resource, latency information associated with backscattering at the EH-capable device, a geographic zone of the EH-capable device, a set of network nodes capable of receiving the backscattering, a set of network nodes capable of interrogating the EH-capable device, a processing capability of the second network node, and a processing capability of the third network node.

16. A first network node for wireless communications, comprising:
a memory; and
at least one processor coupled to the memory, wherein the at least one processor is configured to:
receive, from a second network node, a grant that schedules a communication resource for reception of a backscatter response from an energy harvesting (EH)-capable device, wherein the backscatter response is responsive to a transmission from a third network node to the EH-capable device; and
receive the backscatter response via the communication resource in accordance with the grant.

17. The first network node of claim 16, wherein the grant is downlink control information configured to activate a configured grant occasion for the first network node, wherein the configured grant occasion is the communication resource.

18. The first network node of claim 17, wherein the downlink control information indicates a quantity of slots as a duration for the configured grant occasion.

19. The first network node of claim 18, wherein the at least one processor is further configured to:
receive, prior to reception of the grant, an indication of one or more candidate durations of the configured grant occasion, wherein the quantity of slots indicated in the downlink control information as the duration of the configured grant occasion is a designated one of the one or more candidate durations.

20. The first network node of claim 16, wherein the grant is indicative of a quantity of slots for the reception.

21-45. (canceled)
